(19) United States
(12) Patent Application Publication
(10) Pub. No.: US 2025/0164178 A1
(43) Pub. Date: May 22, 2025

(54) REFRIGERATOR

(71) Applicant: SAMSUNG ELECTRONICS CO., LTD., Suwon-si (KR)

(72) Inventors: Jin JEONG, Suwon-si (KR); Juno KWON, Suwon-si (KR); Joonho PARK, Suwon-si (KR); Hyekyoung AN, Suwon-si (KR)

(73) Assignee: SAMSUNG ELECTRONICS CO., LTD., Suwon-si (KR)

(21) Appl. No.: 18/884,972

(22) Filed: Sep. 13, 2024

Related U.S. Application Data
(63) Continuation of application No. PCT/KR2024/013206, filed on Sep. 3, 2024.

(30) Foreign Application Priority Data
Nov. 16, 2023 (KR) 10-2023-0159595

(51) Int. Cl. F25D 23/02

(52) U.S. Cl. CPC F25D 23/028; F25D 2323/023; F25D 2700/06

(57) ABSTRACT

A refrigerator including a main body including a storage compartment; a door coupled to the main body so as to be rotatable to open and close the storage compartment; and a water supply device at the door, the water supply device including a water supply case including a water bottle mounting space to which a water bottle is mountable, a water level sensor configured to detect, when a water bottle is mounted to the water bottle mounting space, a water level of the water bottle, and a carrier mounted on the water supply case, and to which the water level sensor is coupled, wherein the carrier is mounted on the water supply case to be movable in a vertical direction so that a sensing height at which the water level sensor senses the water level of the water bottle is adjustable.

### CROSS-REFERENCE TO RELATED APPLICATIONS

This application is a continuation application, under 35 U.S.C. § 111(a), of International Application No. PCT/KR2024/013206, filed on Sep. 3, 2024, which claims priority under 35 U.S.C. § 119 to Korean Patent Application No. 10-2023-0159595, filed on Nov. 16, 2023, in the Korean Intellectual Property Office, the disclosures of which are incorporated by reference herein in their entireties.

### TECHNICAL FIELD

The present disclosure relates to a refrigerator, and more particularly, relates to a refrigerator including an automatic water supply device configured to automatically supply water to a water bottle when the water bottle is mounted.

### BACKGROUND ART

A refrigerator is an appliance that keeps food fresh by including a main body with a storage compartment and a cold air supply device configured to supply cold air to the storage compartment.

The refrigerator may include an automatic water supply device that automatically fills a water bottle with water when the water bottle is mounted. The automatic water supply device is equipped with a sensor that detects a water level in the water bottle, and thus the water bottle may be filled up to a full water level on which the sensor is disposed.

The water bottle is always maintained at full water level by the automatic water supply device. In this case, depending on the user's drinking habits, water may be newly filled through the automatic water supply device while the water in the water bottle is not completely empty. Therefore, water stored for a long period of time may accumulate in the water bottle.

### DISCLOSURE

### Technical Problem

The present disclosure is directed to providing a refrigerator including a structure capable of minimizing cold air leakage when accessing a water supply device.

Further, the present disclosure is directed to providing a refrigerator including a structure with improved usability.

Further, the present disclosure is directed to providing a refrigerator including a water supply device capable of controlling a full water level of water stored in a water bottle.

Further, the present disclosure is directed to providing a refrigerator including a structure capable of cooling water using cold air of a storage compartment.

Further, the present disclosure is directed to providing a refrigerator including a structure capable of improving the aesthetics by effectively blocking light from a storage compartment when accessing a water supply device.

### Technical Solution

Aspects of embodiments of the disclosure will be set forth in part in the description which follows and, in part, will be apparent from the description, or may be learned by practice of the presented embodiments.

According to an embodiment of the disclosure, a refrigerator may include a main body including a storage compartment; a door coupled to the main body so as to be rotatable to open and close the storage compartment; and a water supply device at the door. The water supply device may include a water supply case including a water bottle mounting space to which a water bottle is mountable, a water level sensor configured to detect, when a water bottle is mounted to the water bottle mounting space, a water level of the water bottle, and a carrier mounted on the water supply case, and to which the water level sensor is coupled. The carrier may be mounted on the water supply case to be movable in a vertical direction so that a sensing height at which the water level sensor senses the water level of the water bottle is adjustable.

According to an embodiment of the disclosure, the water supply case may include a plurality of locking projections arranged in the vertical direction to support the carrier at a selected sensing height. The carrier may include a locking protrusion to be lockable to, and releasable from, the plurality of locking projections.

According to an embodiment of the disclosure, the water supply case may include a guide rail to guide a movement of the carrier, the guide rail extending along a direction in which the plurality of locking projections extends. The carrier may include a protruding rib arranged to be supported on the guide rail.

According to an embodiment of the disclosure, the door may include an inner door including a door inner space to communicate with the storage compartment, and an outer door configured to be rotatable in front of the inner door. The water supply device may be arranged to be accommodated in the door inner space.

According to an embodiment of the disclosure, the water supply case may include a cutout portion formed to extend in the vertical direction at a rear side of the water bottle mounting space so that, when the water bottle is mounted to the water bottle mounting space, at least one surface of the water bottle communicates with the storage compartment. The carrier may be coupled to the water supply case so as to cover a portion of the cutout portion from the rear side.

According to an embodiment of the disclosure, the carrier may include a body portion to cover a portion of the cutout portion, and a plurality of support portions provided to protrude from both sides of the body portion to support the body portion to the water supply case. The water level sensor may be couplable to the body portion.

According to an embodiment of the disclosure, the water supply case may include a guide hole extending in the vertical direction on a lateral portion of the water bottle mounting space. The carrier may include a handle portion extending forward from one support portion of the plurality of support portions. The handle portion may be disposed to pass through the guide hole and to protrude toward a front side of the water supply case.

According to an embodiment of the disclosure, the refrigerator may further include a rear cover mounted on the water supply case to cover a rear side of the cutout portion so as to partition the water bottle mounting space from the storage compartment.

According to an embodiment of the disclosure, a portion of the rear cover covering the rear side of the cutout portion may include a plurality of holes arranged in a direction in which the cutout portion extends so that the water bottle mounting space communicates with the storage compartment.

According to an embodiment of the disclosure, the carrier may include an auxiliary cover protruding upward from the body portion to cover a portion of an upper side of the cutout portion that is not covered by the body portion.

According to an embodiment of the disclosure, the refrigerator may further include a motor; a first gear coupled to the carrier; and a second gear connecting the motor to the first gear so as to transmit power of the motor to the first gear.

According to an embodiment of the disclosure, the first gear may include a rack gear. The second gear may include a pinion gear.

According to an embodiment of the disclosure, the refrigerator may further include a dispenser including an operating lever and configured to supply water when the operating lever is operated.

According to an embodiment of the disclosure, the door may include a single door. The water supply device may be disposed at a rear side of the single door facing the storage compartment.

According to an embodiment of the disclosure, a refrigerator may include a main body including a storage compartment; an inner door rotatably coupled to the main body; an outer door configured to be rotatable in front of the inner door; a dispenser including an operating lever and configured to supply water by operating the operating lever; and a water supply device disposed at the inner door. The water supply device may include a water supply case including a water bottle mounting space provided to allow a water bottle to be mounted thereto and provided to communicate with the storage compartment. The water supply device may include a water level sensor configured to detect a water level of the water bottle mounted to the water bottle mounting space. The water supply device may include a carrier to which the water level sensor is coupled. The carrier may be mounted on the water supply case to be movable in a vertical direction so as to adjust a sensing height at which the water level sensor senses the water level of the water bottle.

According to an embodiment of the disclosure, a refrigerator may include: a main body including a storage compartment; a door rotatably coupled to the main body so as to open and close the storage compartment; a dispenser including an operating lever and configured to supply water by operating the operating lever; and a water supply device disposed at a rear side of the door facing the storage compartment. The water supply device may include a water supply case including a water bottle mounting space provided to allow a water bottle to be mounted thereto and a plurality of locking projections arranged in a vertical direction. The water supply device may include a water level sensor configured to detect a water level of the water bottle mounted to the water bottle mounting space. The water supply device may include a carrier to which the water level sensor is coupled, the carrier mounted on the water supply case to be movable in the vertical direction so as to adjust a sensing height at which the water level sensor senses the water level of the water bottle. The carrier may include a locking protrusion provided to be locked to or released from the plurality of locking projections.

### DESCRIPTION OF DRAWINGS

These and/or other aspect of the disclosure will become apparent and more readily appreciated from the following description of embodiments, taken in conjunction with the accompanying drawings listed below.

FIG. 1 is a view illustrating an appearance of a refrigerator according to an embodiment of the disclosure.

FIG. 2 is a view illustrating a state in which an outer door of the refrigerator according to an embodiment of the disclosure is open.

FIG. 3 is a view illustrating a state in which an inner door of the refrigerator according to an embodiment of the disclosure is open.

FIG. 4 is a view schematically illustrating a water supply flow path of the refrigerator according to an embodiment of the disclosure.

FIG. 5 is a view illustrating the outer door and the inner door of the refrigerator according to an embodiment of the disclosure.

FIG. 6 is an exploded view of the inner door of the refrigerator according to an embodiment of the disclosure.

FIG. 7 is a view illustrating a flow path structure of a water supply case of the refrigerator according to an embodiment of the disclosure.

FIG. 8 is an exploded view of a water supply unit of the refrigerator according to an embodiment of the disclosure.

FIG. 9 is a control block diagram of the refrigerator according to an embodiment of the disclosure.

FIG. 10 is a flow chart illustrating a method of controlling water supply of the refrigerator according to an embodiment of the disclosure.

FIG. 11 is a perspective view illustrating a state in which a rear cover is separated from the water supply unit of the refrigerator according to an embodiment of the disclosure.

FIG. 12 is an enlarged view of a portion A in FIG. 11.

FIG. 13 is a view illustrating FIG. 12 when viewed from another angle.

FIG. 14 is a view illustrating a carrier separated from the refrigerator according to an embodiment of the disclosure.

FIG. 15 is a view illustrating the carrier separated from the refrigerator according to an embodiment of the disclosure.

FIG. 16 is a top view illustrating the carrier separated from the refrigerator according to an embodiment of the disclosure.

FIG. 17 is a front view of a water supply device of the refrigerator according to an embodiment of the disclosure.

FIG. 18 is a view illustrating a state in which the carrier is lowered in the water supply device of the refrigerator according to an embodiment of the disclosure.

FIG. 19 is a rear perspective view illustrating a state in which the carrier is lowered in FIG. 16 with the rear cover removed.

FIG. 20 is a rear perspective view illustrating a state in which a carrier is lowered in a water supply device of a refrigerator according to an embodiment of the disclosure, with a rear cover removed.

FIG. 21 is a front view illustrating a state in which the carrier of FIG. 20 is lowered.

FIG. 22 is a view illustrating a coupling structure between the water supply unit and the inner door of the refrigerator according to an embodiment of the disclosure.

FIG. 23 is a view illustrating a coupling structure of a door basket of the refrigerator according to an embodiment of the disclosure.

FIG. 24 is a side cross-sectional view illustrating the water supply device equipped with a water bottle of the refrigerator according to an embodiment of the disclosure.

FIG. 25 is a side cross-sectional view illustrating the water supply device equipped with the water bottle of the refrigerator according to an embodiment of the disclosure.

FIG. 26 is a view illustrating a state in which the water bottle is separated from the water supply device of the refrigerator according to an embodiment of the disclosure.

FIG. 27 is a view illustrating a rear surface of the inner door of the refrigerator according to an embodiment of the disclosure.

FIG. 28 is a cross-sectional view of the water supply case illustrating a flow of cold air in the refrigerator according to an embodiment of the disclosure.

FIG. 29 is a view illustrating a front surface of the inner door of the refrigerator according to an embodiment of the disclosure.

FIG. 30 is a view illustrating a state in which an outer door of a refrigerator according to an embodiment of the disclosure is open.

FIG. 31 is a view illustrating a state in which an outer door of a refrigerator according to an embodiment of the disclosure is open.

FIG. 32 is a view illustrating a state in which an outer door of a refrigerator according to an embodiment of the disclosure is open.

FIG. 33 is a view illustrating a state in which an outer door of a refrigerator according to an embodiment of the disclosure is open.

FIG. 34 is a view illustrating a state in which a single door of a refrigerator according to an embodiment of the disclosure is open.

### MODES OF THE INVENTION

Various embodiments of the present document and terms used therein are not intended to limit the technical features described in this document to specific embodiments, and should be understood to include various modifications, equivalents, or substitutes of the corresponding embodiments.

In connection with the description of the drawings, similar reference numerals may be used for similar or related components.

The singular form of a noun corresponding to an item may include one or a plurality of the items unless clearly indicated otherwise in a related context.

In this document, phrases, such as “A or B”, “at least one of A and B”, “at least one of A or B,” “A, B or C,” “at least one of A, B and C,” and “at least one of A, B, or C”, may include any one or all possible combinations of items listed together in the corresponding phrase among the phrases.

As used herein, the term “and/or” includes any and all combinations of one or more of associated listed items.

Terms such as “1st”, “2nd”, “primary”, or “secondary” may be used simply to distinguish a component from other components, without limiting the component in other aspects (e.g., importance or order).

Further, as used in the disclosure, the terms “front”, “rear”, “top”, “bottom”, “side”, “left”, “right”, “upper”, “lower”, and the like are defined with reference to the drawings, and are not intended to limit the shape and position of each component.

It will be understood that when the terms “includes,” “comprises,” “including,” and/or “comprising,” when used in this specification, specify the presence of stated features, figures, steps, operations, components, members, or combinations thereof, but do not preclude the presence or addition of one or more other features, figures, steps, operations, components, members, or combinations thereof.

It will be understood that when a certain component is referred to as being “connected to”, “coupled to”, “supported by” or “in contact with” another component, it can be directly or indirectly connected to, coupled to, supported by, or in contact with the other component. When a component is indirectly connected to, coupled to, supported by, or in contact with another component, it may be connected to, coupled to, supported by, or in contact with the other component through a third component.

It will also be understood that when a component is referred to as being “on” another component, it can be directly on the other component or intervening components may also be present.

A refrigerator according to an embodiment of the disclosure may include a main body.

The “main body” may include an inner case, an outer case positioned outside the inner case, and an insulation provided between the inner case and the outer case.

The “inner case” may include a case, a plate, a panel, or a liner forming a storage compartment (also referred to as a storage room). The inner case may be formed as one body, or may be formed by assembling a plurality of plates together. The “outer case” may form an appearance of the main body, and be coupled to an outer side of the inner case such that the insulation is positioned between the inner case and the outer case.

The “insulation” may insulate inside of the storage compartment from outside of the storage compartment to maintain inside temperature of the storage compartment at appropriate temperature without being influenced by an external environment of the storage compartment. According to an embodiment of the disclosure, the insulation may include a foaming insulation. The foaming insulation may be molded by fixing the inner case and the outer case with jigs, etc., and then injecting and foaming urethane foam as a mixture of polyurethane and a foaming agent between the inner case and the outer case.

According to an embodiment of the disclosure, the insulation may include a vacuum insulation in addition to a foaming insulation, or may be configured only with a vacuum insulation instead of a forming insulation. The vacuum insulation may include a core material and a cladding material accommodating the core material and sealing the inside with vacuum or pressure close to vacuum. The vacuum insulation may further include an adsorbent for adsorbing a gas and water to stably maintain a vacuum state. However, the insulation is not limited to the above-mentioned foaming insulation or vacuum insulation, and may include various materials capable of being used for insulation.

The “storage compartment” may include a space defined by the inner case. The storage compartment may further include the inner case defining the space. Medicines or cosmetics, as well as food items, may be stored in the storage compartment, and one side of the storage compartment may open to enable a user to put items in or take items out.

The refrigerator may include one or more storage compartments. In a case in which two or more storage compartments are formed in the refrigerator, the respective storage compartments may have different purposes of use, and may be maintained at different temperature. To this end, the respective storage compartments may be partitioned by a partition wall including an insulation.

The storage compartment may be maintained within an appropriate temperature range according to a purpose of use, and include a “refrigerating compartment”, a “freezing compartment”, and a “temperature conversion compartment” according to purposes of use and/or temperature ranges. The refrigerating compartment may be maintained at appropriate temperature to keep food refrigerating, and the freezing compartment may be maintained at appropriate temperature to keep food frozen. The “refrigerating” may be keeping food cold without freezing the food, and for example, the refrigerating compartment may be maintained within a range of 0 degrees Celsius to 7 degrees Celsius. The “freezing” may be freezing food or keeping food frozen, and for example, the freezing compartment may be maintained within a range of −20 degrees Celsius to −1 degrees Celsius. The temperature conversion compartment may be used as any one of a refrigerating compartment or a freezing compartment according to or regardless of a user's selection.

The storage compartment may also be called various other terms, such as “vegetable compartment”, “freshness compartment”, “cooling compartment”, and “ice-making compartment”, in addition to “refrigerating compartment”, “freezing compartment”, and “temperature conversion compartment”, and the terms, such as “refrigerating compartment”, “freezing compartment”, “temperature conversion compartment”, etc., as used below need to be understood to represent storage compartments having the corresponding purposes of use and the corresponding temperature ranges.

The refrigerator according to an embodiment of the disclosure may include at least one door configured to open or close the open side of the storage compartment. The respective doors may be provided to open and close one or more storage compartments, or a single door may be provided to open and close a plurality of storage compartments. The door may be rotatably or slidably mounted on the front of the main body.

The “door” may seal the storage compartment in a closed state. The door may include an insulation, like the main body, to insulate the storage compartment in the closed state.

According to an embodiment, the door may include an outer door plate forming the front surface of the door, an inner door plate forming the rear surface of the door and facing the storage compartment, an upper cap, a lower cap, and a door insulation provided therein.

A gasket may be provided on the edge of the inner door plate to seal the storage compartment by coming into close contact with the front surface of the main body when the door is closed. The inner door plate may include a dyke that protrudes rearward to allow a door basket for storing items to be fitted.

According to an embodiment, the door may include a door body and a front panel that is detachably coupled to the front of the door body and forms the front surface of the door. The door body may include an outer door plate that forms the front surface of the door body, an inner door plate that forms the rear surface of the door body and faces the storage compartment, an upper cap, a lower cap, and a door insulator provided therein.

The refrigerator may be classified as French Door Type, Side-by-side Type, Bottom Mounted Freezer (BMF), Top Mounted Freezer (TMF), or One Door Refrigerator depending on the arrangement of the doors and the storage compartments.

The refrigerator according to an embodiment of the disclosure may include a cold air supply device for supplying cold air to the storage compartment.

The “cold air supply device” may include a machine, an apparatus, an electronic device, and/or a combination system thereof, capable of generating cold air and guiding the cool air to cool the storage compartment.

According to an embodiment of the disclosure, the cold air supply device may generate cold air through a cooling cycle including compression, condensation, expansion, and evaporation processes of refrigerants. To this end, the cold air supply device may include a cooling cycle device having a compressor, a condenser, an expander, and an evaporator to drive the cooling cycle. According to an embodiment of the disclosure, the cold air supply device may include a semiconductor such as a thermoelectric element. The thermoelectric element may cool the storage compartment by heating and cooling actions through the Peltier effect.

The refrigerator according to an embodiment of the disclosure may include a machine compartment where at least some components belonging to the cold air supply device are installed.

The “machine compartment” may be partitioned and insulated from the storage compartment to prevent heat generated from the components installed in the machine compartment from being transferred to the storage compartment. To dissipate heat from the components installed inside the machine compartment, the machine compartment may communicate with outside of the main body.

The refrigerator according to an embodiment of the disclosure may include a dispenser provided on the door to provide water and/or ice. The dispenser may be provided on the door to allow access by the user without opening the door.

The refrigerator according to an embodiment of the disclosure may include an ice-making device that produces ice. The ice-making device may include an ice-making tray that stores water, an ice-moving device that separates ice from the ice-making tray, and an ice-bucket that stores ice generated in the ice-making tray.

The refrigerator according to an embodiment of the disclosure may include a controller for controlling the refrigerator.

The “controller” may include a memory for storing and/or memorizing data and/or programs for controlling the refrigerator, and a processor for outputting control signals for controlling the cold air supply device, etc., according to the programs and/or data memorized in the memory.

The memory may store or record various information, data, commands, programs, and the like necessary for operations of the refrigerator. The memory may store temporary data generated while generating control signals for controlling components included in the refrigerator. The memory may include at least one of volatile memory or non-volatile memory, or a combination thereof.

The processor may control the overall operation of the refrigerator. The processor may control the components of the refrigerator by executing programs stored in memory. The processor may include a separate neural processing unit (NPU) that performs an operation of an artificial intelligence (AI) model. In addition, the processor may include a central processing unit (CPU), a graphics processor (GPU), and the like. The processor may generate a control signal to control the operation of the cold air supply device. For example, the processor may receive temperature information of the storage compartment from a temperature sensor, and generate a cooling control signal for controlling an operation of the cold air supply device based on the temperature information of the storage compartment.

Furthermore, the processor may process a user input of a user interface and control an operation of the user interface according to the programs and/or data memorized/stored in the memory. The user interface may be provided using an input interface and an output interface. The processor may receive the user input from the user interface. In addition, the processor may transmit a display control signal and image data for displaying an image on the user interface to the user interface in response to the user input.

The processor and memory may be provided integrally or may be provided separately. The processor may include one or more processors. For example, the processor may include a main processor and at least one sub-processor. The memory may include one or more memories.

The refrigerator according to an embodiment of the disclosure may include a processor and a memory for controlling all the components included in the refrigerator, and may include a plurality of processors and a plurality of memories for individually controlling the components of the refrigerator. For example, the refrigerator may include a processor and a memory for controlling the operation of the cold air supply device according to an output of the temperature sensor. In addition, the refrigerator may be separately equipped with a processor and a memory for controlling the operation of the user interface according to the user input.

A communication module may communicate with external devices, such as servers, mobile devices, and other home appliances via a nearby access point (AP). The AP may connect a local area network (LAN) to which a refrigerator or a user device is connected to a wide area network (WAN) to which a server is connected. The refrigerator or the user device may be connected to the server via the WAN.

The input interface may include keys, a touch screen, a microphone, and the like. The input interface may receive the user input and pass the received user input to the processor.

The output interface may include a display, a speaker, and the like. The output interface may output various notifications, messages, information, and the like generated by the processor.

Hereinafter, various embodiments according to the disclosure will be described in detail with reference to the accompanying drawings.

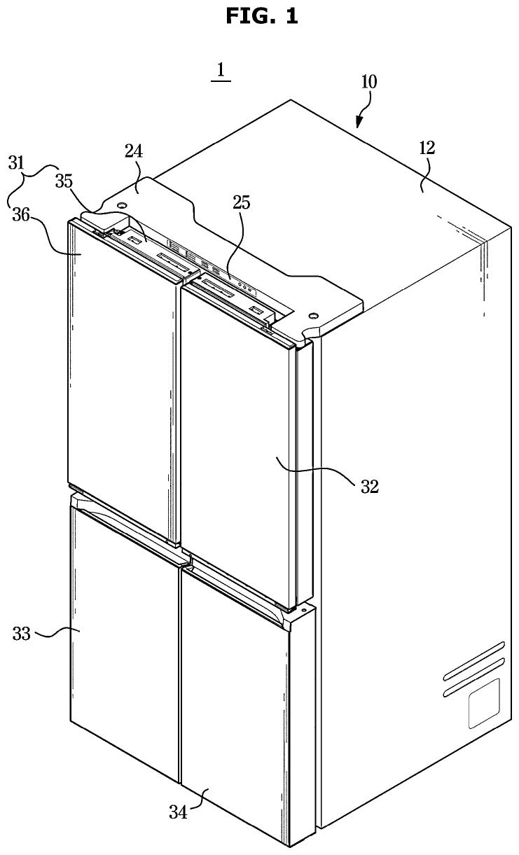

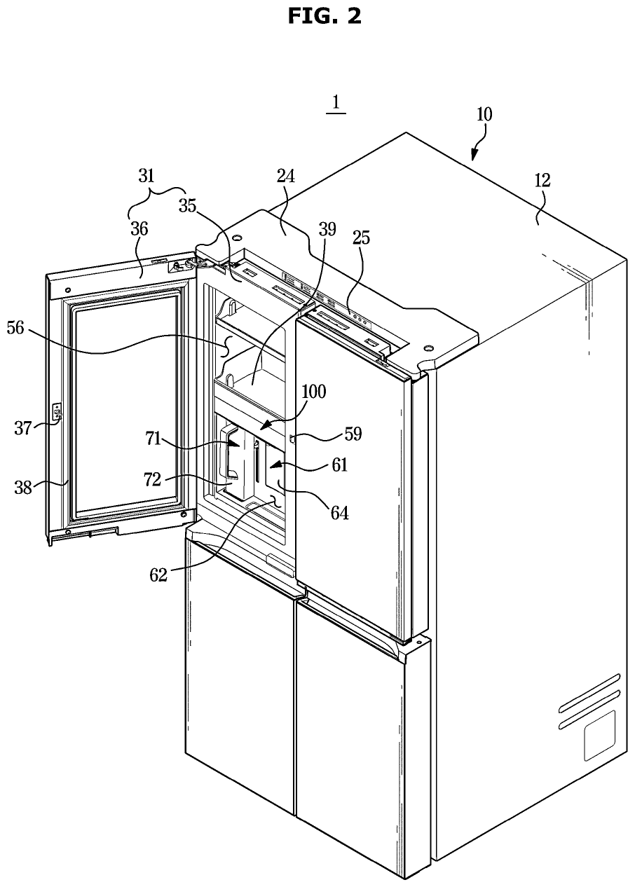

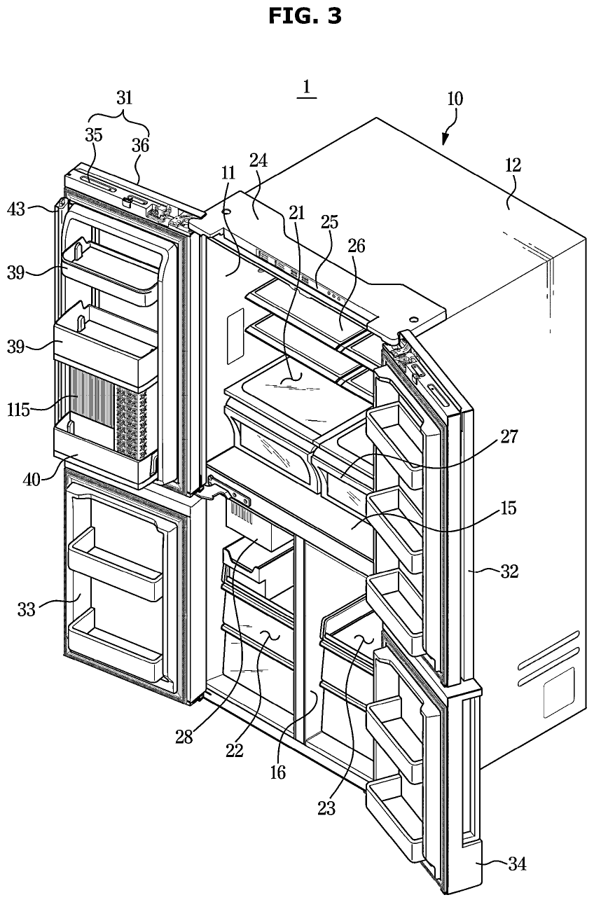

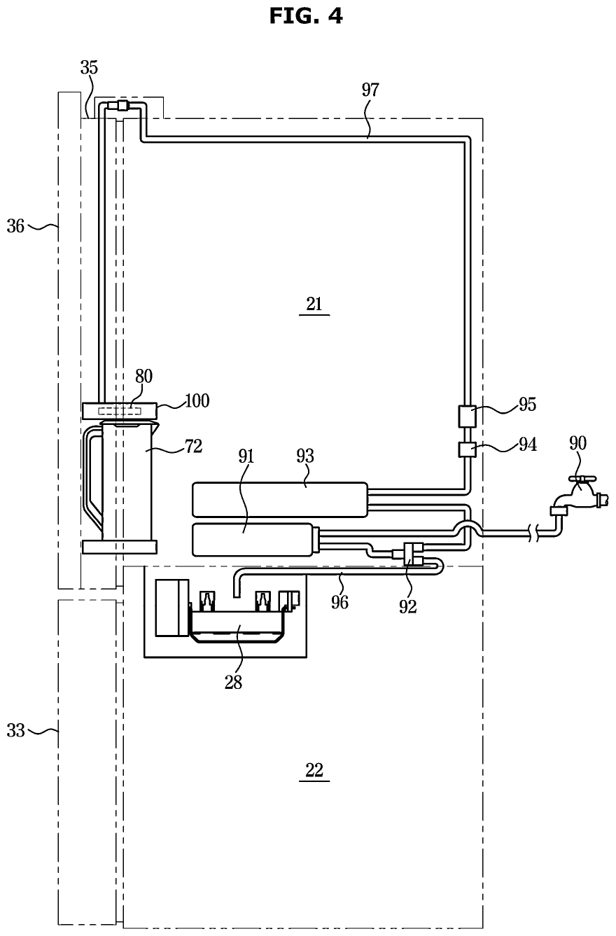

FIG. 1 is a view illustrating an appearance of a refrigerator according to an embodiment of the disclosure. FIG. 2 is a view illustrating a state in which an outer door of the refrigerator according to an embodiment of the disclosure is open. FIG. 3 is a view illustrating a state in which an inner door of the refrigerator according to an embodiment of the disclosure is open. FIG. 4 is a view schematically illustrating a water supply flow path of the refrigerator according to an embodiment of the disclosure.

Referring to FIGS. 1 to 4, a refrigerator 1 according to an embodiment of the disclosure of the present disclosure may include a main body 10, storage compartments 21, 22, and 23 formed inside the main body 10, doors 31, 32, 33, and 34 configured to open and close the storage compartments 21, 22, and 23, and a cold air supply device (not shown) configured to supply cold air to the storage compartments 21, 22, and 23.

The main body 10 may include an inner case 11 provided to form the storage compartments 21, 22, and 23, an outer case 12 coupled to an outside of the inner case 11 to form an exterior, and an insulating material (not shown) disposed between the inner case 11 and the outer case 12 to insulate the storage compartments 21, 22, and 23.

The storage compartments 21, 22, and 23 may be divided into a plurality of compartments by a horizontal partition 15 and a vertical partition 16. The storage compartments 21, 22, and 23 may be divided into an upper storage compartment 21 and lower storage compartments 22 and 23 by the horizontal partition 15, and the lower storage compartments 22 and 23 may be divided into a left lower storage compartment 22 and a right lower storage compartment 23 by the vertical partition 16.

The upper storage compartment 21 may be used as a refrigerating compartment, and the lower storage compartments 22 and 23 may be used as a freezing compartment. However, the division and use of the storage compartments 21, 22, and 23 as described above is only an example and is not limited thereto.

In addition, unlike the embodiment, the refrigerator may be a Side By Side (SBS) type in which storage compartments are divided into left and right sides by a vertical partition, a French Door Refrigerator (FDR) type in which storage compartments are divided into an upper refrigerating compartment and a lower refrigerating compartment by a horizontal partition or a one-door type with one storage compartment and one door.

A shelf 26 on which food is placed and a storage container 27 in which food is stored may be disposed inside the storage compartments 21, 22, and 23.

The cold air supply device may generate cold air using a refrigeration circulation cycle that compresses, condenses, expands, and evaporates a refrigerant, and the cold air supply device may supply the generated cold air to the storage compartments 21, 22, and 23.

The upper storage compartment 21 may be opened and closed by a pair of doors 31 and 32. The doors 31 and 32 may be rotatably coupled to the main body 10. A pillar 43 provided to prevent cold air of the storage compartment 21 from leaking out between the pair of doors 31 and 32 when the pair of doors 31 and 32 is closed may be disposed in one of the pair of doors 31 and 32.

The lower left storage compartment 22 may be opened and closed by a door 33, and the door 33 may be rotatably coupled to the main body 10. The lower right storage compartment 23 may be opened and closed by a door 34, and the door 34 may be rotatably coupled to the main body 10.

The doors 31, 32, 33, and 34 may include door baskets 39 and 40 including a door storage space in which food is stored. A gasket provided to be in close contact with a front surface of the main body 10 may be provided on rear surfaces of the doors 31, 32, 33, and 34 to seal the storage compartments 21, 22, and 23.

At least one of the doors 31, 32, 33, and 34 may be configured as a double door including an inner door 35 and an outer door 36. For example, the upper left door 31 may include the inner door 35 and the outer door 36.

The inner door 35 may be rotatably coupled to the main body 10 through a hinge. The inner door 35 may include a door inner space 56. The door inner space 56 may be formed in a central portion of the inner door 35 excluding an edge portion. The door inner space 56 may be formed to extend between the front and rear surfaces of the inner door 35. Accordingly, when the inner door 35 is closed, the door inner space 56 may communicate with the storage compartment 21.

The door baskets 39 and 40 may be mounted on the opening 56.

A dispenser 61 may be provided in the opening 56. The dispenser 61 may include an operating lever 64 configured to operate the dispenser 61 to allow water to be supplied. A user can press the operating lever 64 using a container such as a cup (not shown). The operating lever 64 may be movably installed on a lever installation portion 110 formed in a water supply case 100. The water supply case 100 may be included in a water supply device 71, which will be described later. The water supply case 100 may form an appearance of the water supply device 71.

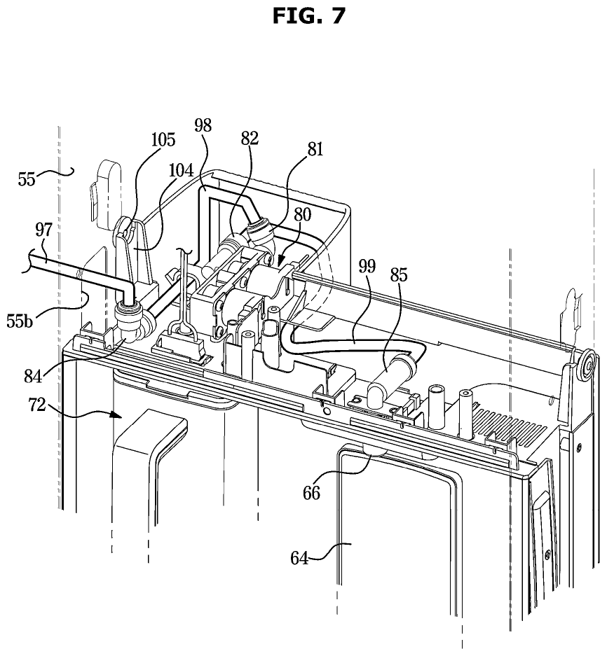

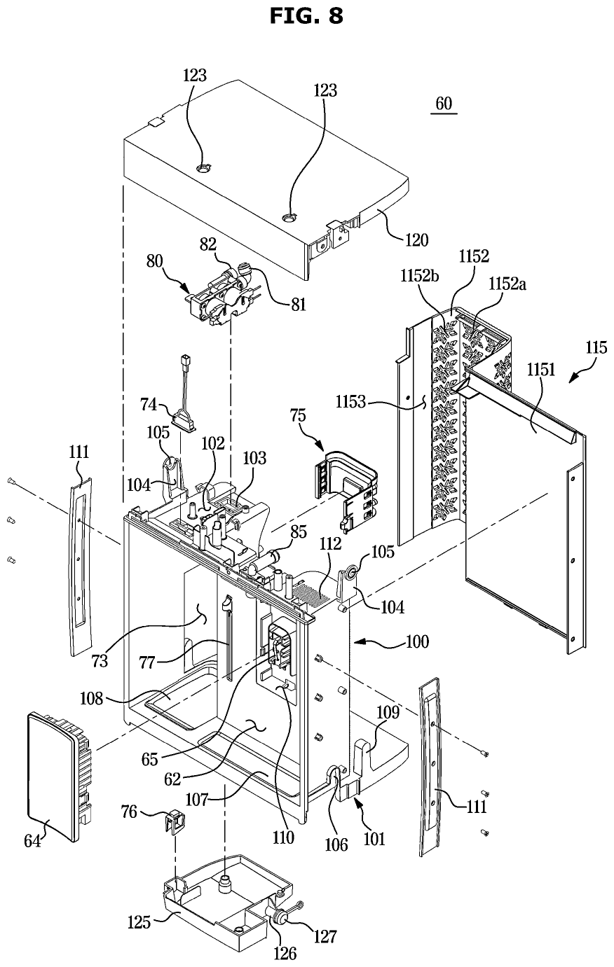

The dispenser 61 may further include a switch 65 (FIG. 8) configured to be turned on by the operating lever 64 when the operating lever 64 is pressed. The dispenser 61 may include a dispenser nozzle 66 (FIG. 7) through which water is discharged. The dispenser nozzle 66 may be installed in the water supply case 100.

The dispenser 61 may include a water intake space 62 in which a container may be placed to receive water discharged from the dispenser nozzle 66. The water intake space 62 may be formed to be recessed on a front surface of the water supply case 100. However, unlike the embodiment, when the dispenser nozzle 66 is formed to protrude to the front side of the water supply case 100, the water intake space 62 may not be provided.

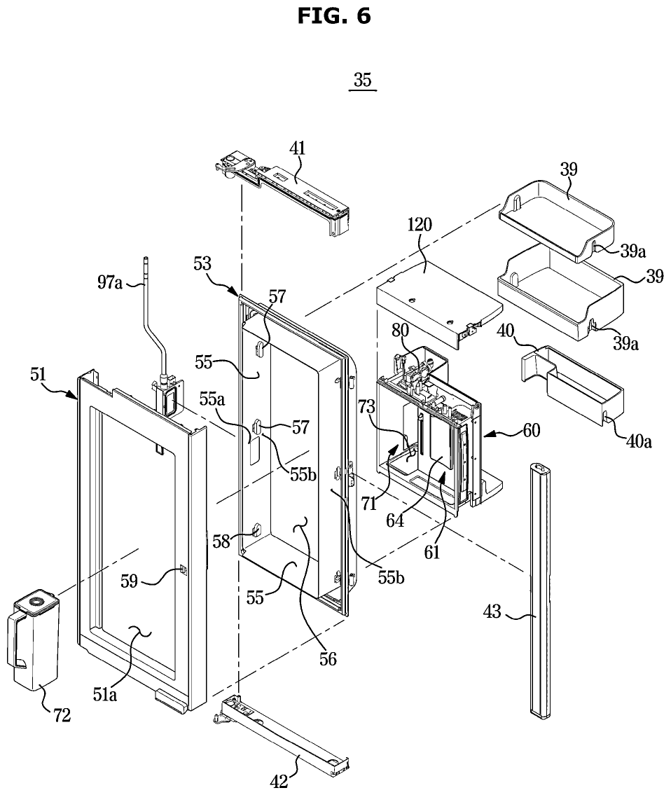

The water supply device 71 including a water bottle mounting space 73 (FIG. 6), in which a water bottle 72 is mounted, and a water level sensor 75a configured to detect a water level of the water bottle 72 when the water bottle 72 is mounted on the water bottle mounting space 73 may be provided in the door inner space 56. In other words, the water bottle mounting space 73 in which the water bottle 72 is mounted may be formed in the water supply case 100.

The water level sensor 75a may be configured to sense the level of water contained in the water bottle 72. In addition, the water supply device 71 may include a carrier 75 (FIG. 8) mounted on the water supply case 100 to be vertically movable so as to adjust a height at which the water level sensor 75a senses a water level of the water bottle. As will be described later, the height at which the water level sensor 75a senses the level of water in the water bottle 72 may be defined as a sensing height. A detailed description of the carrier 75 will be provided later.

The water supply device 71 may include an outlet that supplies water to the water bottle 72 mounted on the water bottle mounting space 73. That is, the water supply device 71 may be disposed in the door 31.

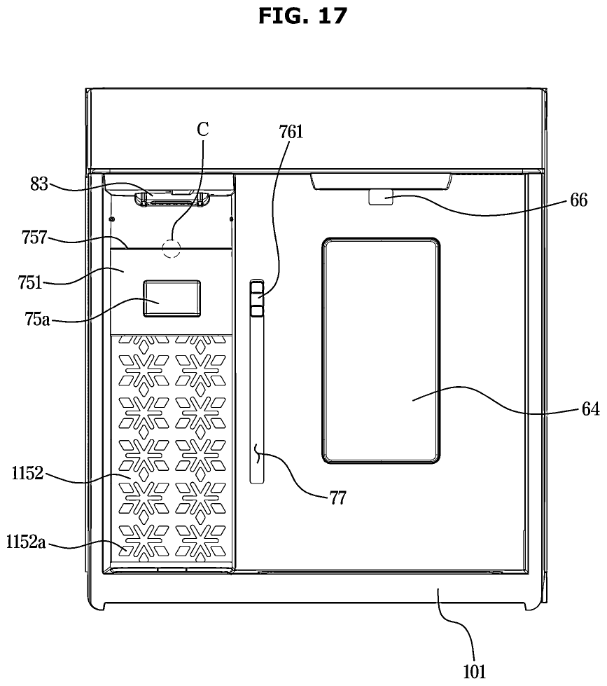

In an embodiment of the present disclosure, the outlet may be implemented as a second outlet port 83 (FIG. 17) of a control valve 80. However, unlike the embodiment, the outlet may be implemented as a separate component rather than the second outlet port 83 of the control valve 80. In this case, the outlet may be connected to the second outlet port 83 through a separate flow path.

The water supply device 71 may automatically supply water to the water bottle 72 to allow the water bottle 72 to be filled with a predetermined amount of water when the water bottle 72 is mounted on the water bottle mounting space 73. That is, the water supply device 71 may perform an autofill-function. The predetermined amount may be approximately the full amount of water of the water bottle 72.

The water bottle mounting space 73 may be formed to be recessed on the front surface of the water supply case 100. The water intake space 62 and the water bottle mounting space 73 may be in communication with each other. For example, the water supply device 71 may be arranged to be accommodated in the door inner space 56. That is, the water supply case 100 may be mounted on the door inner space 56.

The water level sensor 75a may be installed in the water supply case 100. The outlet may be installed in the water supply case 100.

As mentioned above, the operating lever 64, the switch 65, and the dispenser nozzle 66 of the dispenser 61 may be installed or supported on the water supply case 100, and the water level sensor 75a and the outlet of the water supply device 71 may be installed or supported on the water supply case 100. Additionally, the water bottle mounting space 73 of the water supply device 71 may be formed by the water supply case 100.

Therefore, the dispenser 61 and the water supply device 71 may be provided as one assembly. In the present disclosure, the assembly may be referred to as a water supply unit 60.

The water supply unit 60 may be disposed in the door inner space 56 of the inner door 35. Particularly, the water supply case 100 of the water supply unit 60 may be mounted on a door inner surface 55 provided to form the door inner space 56.

As described above, when the inner door 35 is closed, the door inner space 56 may communicate with the storage compartment 21, and thus the water supply unit 60 may be cooled by cold air of the storage compartment 21. Further, the water intake space 62 and the water bottle mounting space 73 may be formed on the front surface of the water supply case 100. Therefore, the water intake space 62 and the water bottle mounting space 73 may be accessed even when the inner door 35 is closed.

The outer door 36 may be configured to open and close the door inner space 56 of the inner door 35. A gasket 38 may be provided on a rear surface of the outer door 36 to seal the door inner space 56. The gasket 38 may be in close contact with the front surface of the inner door 35 around the door inner space 56.

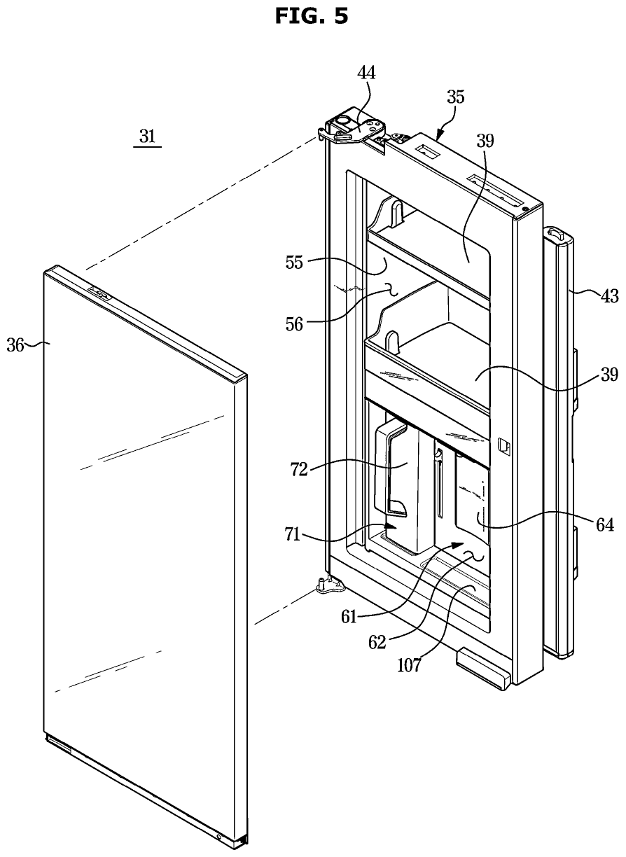

When the outer door 36 is opened, the door inner space 56 of the inner door 35 may be accessed. The outer door 36 may be rotatably coupled to a front side of the inner door 35 through a hinge 44 (FIG. 5). The outer door 36 may rotate in the same direction as the inner door 35. The outer door 36 may have a size corresponding to a size of the inner door 35. The outer door 36 may cover an entire area of the inner door 35.

The outer door 36 may be provided with a latch 37 for fixation with the inner door 35, and a catch 59 may be provided on the inner door 35 to engage with the latch 37.

When the outer door 36 is opened in a state in which the latch 37 and the catch 59 are engaged with each other, the outer door 36 may be opened together with the inner door 35. When the outer door 36 is opened in a state in which the latch 37 and the catch 59 are not engaged with each other, the outer door 36 may be opened but the inner door 35 may not be opened.

A decorative panel (not shown) may be removably coupled to the front surface of the outer door 36.

A top cover 24 may be coupled to an upper surface of the main body 10. The top cover 24 may be provided to cover the hinge and various electrical components disposed on the upper surface of the main body 10. A control panel 25 may be provided on a front surface of the top cover 24 to display various status and operation information of the refrigerator 1 or to receive various commands for operating the refrigerator 1.

As illustrated in FIG. 4, the refrigerator 1 may include a water filter 91 and a water tank 93. The water filter 91 may purify water supplied from an external water supply source 90. The water tank 93 may store water purified through the water filter 91. The water tank 93 may be cooled by cold air of the storage compartment 21.

An ice maker 28 configured to produce ice may be disposed in the storage compartment 22 of the refrigerator 1. The ice maker 28 may produce ice using cold air of the storage compartment 22.

The refrigerator 1 may include a water supply flow path 97 provided to form a flow path provided to connect the external water supply source 90 and the control valve 80 so as to supply water to the dispenser 61 and the water supply device 71, and an ice maker flow path 96 provided to connect the external water supply source 90 and the ice maker 28 to supply water to the ice maker 28.

The ice maker flow path 96 and the water supply flow path 97 may be formed to branch at one point, and a flow path switching valve 92 may be disposed at the branch point to allow water, which is supplied from the external water supply source 90, to be selectively supplied to the control valve 80 or the ice maker 28. Water from the external water supply source 90 may be supplied to the control valve 80 or the ice maker 28 by controlling a water pressure of the external water supply source 90 and by controlling the flow path switching valve 92.

The water supply flow path 97 may be provided to pass through the water filter 91. Accordingly, water from the external water supply source 90 may be purified through the water filter 91 and supplied to the control valve 80. The water supply flow path 97 may be provided to pass through the water tank 93. Accordingly, water from the external water supply source 90 may be cooled in the water tank 93 and then supplied to the control valve 80.

A water valve 94 may be provided in the water supply flow path 97. The water valve 94 may regulate an amount of water supplied from the water tank 93 to the control valve 80. A flow sensor 95 may be provided in the water supply flow path 97 to measure the amount of water supplied to the control valve 80.

The ice maker flow path 96 may be provided to pass through the water filter 91. Accordingly, water from the external water supply source 90 may be purified through the water filter 91 and then supplied to the ice maker 28. Because the water supplied to the ice maker 28 is cooled in the ice maker 28 even when the water is not cooled in the water tank 93, the ice maker flow path 96 may not pass through the water tank 93.

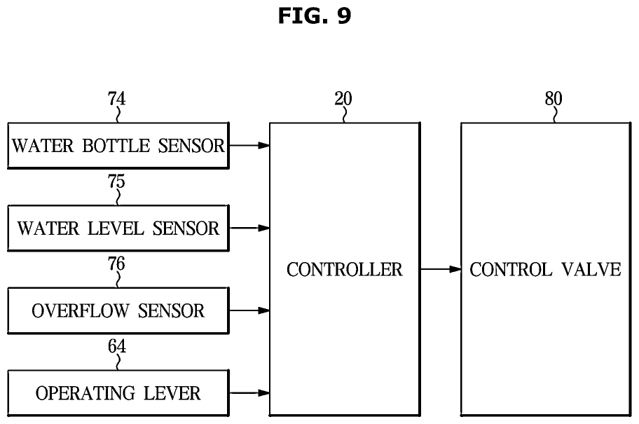

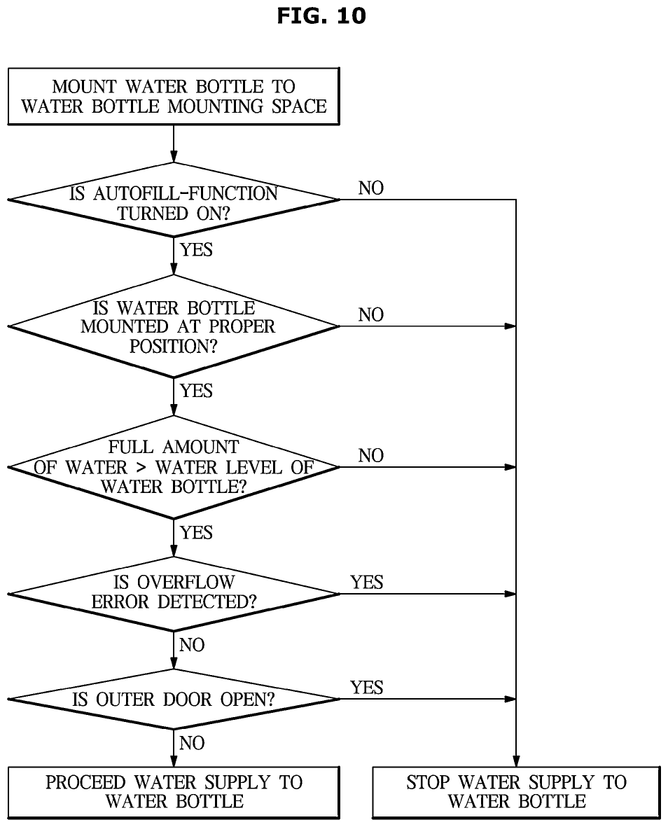

FIG. 5 is a view illustrating the outer door and the inner door of the refrigerator according to an embodiment of the disclosure. FIG. 6 is an exploded view of the inner door of the refrigerator according to an embodiment of the disclosure. FIG. 7 is a view illustrating a flow path structure of a water supply case of the refrigerator according to an embodiment of the disclosure. FIG. 8 is an exploded view of a water supply unit of the refrigerator according to an embodiment of the disclosure. FIG. 9 is a control block diagram of the refrigerator according to an embodiment of the disclosure. FIG. 10 is a flow chart illustrating a method of controlling water supply of the refrigerator according to an embodiment of the disclosure.

Referring to FIGS. 5 to 10, the inner door 35 may include a front plate 51, a rear plate 53, an upper cap 41, and a lower cap 42. A foam space may be formed between the front plate 51, the rear plate 53, the upper cap 41, and the lower cap 42, and an insulating material (not shown) may be disposed in the foam space. A foam insulating material composed of urethane may be used as the insulating material. Further, vacuum insulating material may be used together with the foam insulating material as the insulating material.

The front plate 51 may form the front surface and both side surfaces of the inner door 35. The front plate 51 may include a front plate opening 51a excluding an edge portion of the front plate 51.

The catch 59 provided to engage with the latch 37 of the outer door 36 may be disposed in the front plate 51.

The rear plate 53 may include the door inner space 56 formed in a central portion excluding the edge portion of the rear plate 53. The rear plate 53 may include the door inner surface 55 that forms the door inner space 56. The door inner surface 55 may be formed on up, down, left, and right sides of the door inner space 56 to form the door inner space 56. However, unlike the embodiment, the door inner surface 55 may be formed by the front plate 51, or by the front plate 51 and the rear plate 53.

A first door bead 57 protruding from the door inner surface 55 to the door inner space 56 may be formed on the door inner surface 55 to allow the door basket 39 to be mounted thereto. The door basket 39 may be mounted on the door inner surface 55 through the first door bead 57.

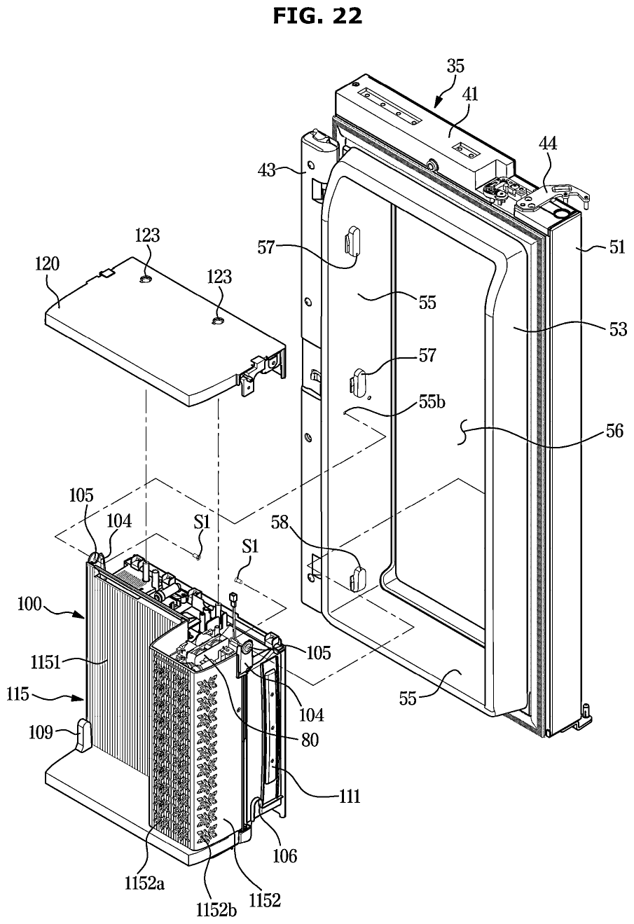

A second door bead 58 protruding to the door inner space 56 may be formed on the door inner surface 55 to allow the water supply case 100 to be mounted thereto. The water supply case 100 may be mounted on the door inner surface 55 through the second door bead 58. A fastening hole 55b may be formed in the door inner surface 55 to allow the water supply unit 60 to be coupled to the door inner space 55 through a fastening member S1 (FIG. 22).

A through-hole 55a, through which an electric wire and hose connected to the water supply unit 60 pass, may be formed in the door inner surface 55. The water supply flow path 97, which is inserted into the inner door 35 by passing through a hinge shaft on the upper side of the inner door 35, may be guided to the water supply case 100 through a flow path guide 97a (FIG. 6) and the through-hole 55a.

Referring to FIG. 8, the water supply case 100 may include a main case 101, a rear cover 115 coupled to a rear side of the main case 101, a case cover 120 coupled to an upper portion of the main case 101, and a tray 125 coupled to a lower portion of the main case 101.

The water intake space 62 and the water bottle mounting space 73 may be formed on a front surface of the main case 101. The water intake space 62 and the water bottle mounting space 73 may be formed in left and right directions. The water intake space 62 and the water bottle mounting space 73 may be formed to communicate with each other.

A container support portion 107 provided to support a container that receives water discharged into the water intake space 62, and a water bottle support portion 108 provided to support the water bottle 72 provided to receive water discharged through the water supply device 71 may be formed in the lower portion of the main case 101.

The main case 101 may include the lever installation portion 110 on which the operating lever 64 of the dispenser 61 is mounted, and the lever installation portion 110 may be provided with the switch 65 configured to be turned on or off according to a position of the operating lever 64.

A reinforcing member 111 may be coupled to both side surfaces of the main case 101 to prevent shrinkage and deformation of the main case 101 caused by cooling. The reinforcing member 111 may be formed of a steel plate material. The reinforcing member 111 may be arranged to be long in the vertical direction on the both side surfaces of the main case 101.

A valve mounting space 102 (FIG. 8) may be formed on an upper surface of the main case 101. The control valve 80 may be mounted on the valve mounting space 102, and the control valve 80 may not be exposed to the outside by the case cover 120 coupled to the upper portion of the main case 101. That is, the valve mounting space 102 may be formed between the main case 101 and the case cover 120. The case cover 120 may be coupled to the upper portion of the main case 101 through a fastening member such as a screw. For this, a coupling hole 123 into which the fastening member is coupled may be formed in the case cover 120.

The control valve 80 may guide water, which is supplied from the external water supply source 90 through the water supply flow path 97, to the water intake space 62 or the water bottle 72. The control valve 80 may have a form such as a three-way valve. Particularly, the control valve 80 may include an inlet port 81 connected to the water supply flow path 97 to receive water from the external water supply source 90, a first outlet port 82 provided to supply water toward the water intake space 62, and the second outlet port 83 provided to supply water to the water bottle 72. The first outlet port 82 and the second outlet port 83 may be provided to be selectively opened and closed.

Referring to FIG. 7, the water supply flow path 97 guided to the water supply case 100 through the through-hole 55a may be connected to one end of a first fitting member 84. The other end of the first fitting member 84 and the inlet port 81 of the control valve 80 may be connected through a connection flow path 98. However, unlike the embodiment, the first fitting member 84 may be omitted, and the water supply flow path 97 may be directly connected to the inlet port 81 of the control valve 80.

The first outlet port 82 of the control valve 80 may be connected to one end of a second fitting member 85 disposed on the upper surface of the main case 101 through a second connection flow path 99. The dispenser nozzle 66 (FIG. 7) may be coupled to the other end of the second fitting member 85. The dispenser nozzle 66 may be removably coupled to the other end of the second fitting member 85.

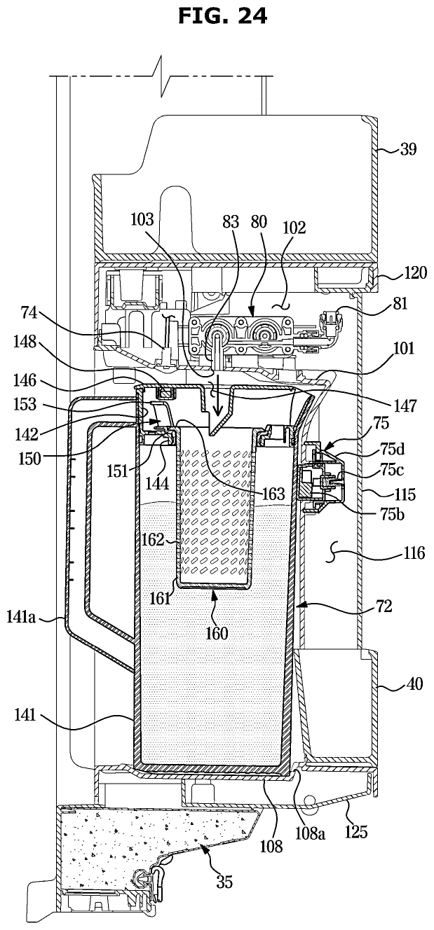

The second outlet port 83 (FIG. 17) may be formed to protrude to a lower side of the control valve 80. The second outlet port 83 may be disposed in a valve through-hole 103 formed on the upper surface of the main case 101. The water discharged from the second outlet port 83 may fall in the direction of gravity and flow directly into an inlet 147 of the water bottle 72 without a separate connecting member (FIG. 24). Therefore, as described above, the second outlet port 83 may be referred to as the outlet of the water supply device 71.

The refrigerator 1 may include a water bottle sensor 74 configured to detect whether the water bottle 72 is mounted on the water bottle mounting space 73. The control valve 80 may be configured to block water supply to the water bottle 72 when the water bottle sensor 74 detects that the water bottle 72 is not mounted on the water bottle mounting space 73. That is, the control valve 80 may be configured to supply water to the water bottle 72 only when the water bottle 72 is mounted on the water bottle mounting space 73.

The control valve 80 may be configured to block water supply to the water bottle 72 when the water level sensor 75a detects that a predetermined amount of water is stored in the water bottle 72. On the other hand, the control valve 80 may be configured to supply water to the water bottle 72 when the water level sensor 75a detects that a predetermined amount of water is not stored in the water bottle 72. That is, the control valve 80 may be configured to open and close the second outlet port 83 according to the water level inside the water bottle 72 detected by the water level sensor 75a.

The control valve 80 may be configured to block water supply to the water bottle 72 when an overflow sensor 76 detects that a predetermined amount of water is collected in the tray 125.

When a predetermined signal is input to the operating lever 64, the control valve 80 may open the first outlet port 82 provided to supply water toward the water intake space 62.

The tray 125 may be provided at the lower portion of the main case 101. The tray 125 may store water flowing out of the water bottle 72 mounted on the water bottle mounting space 73. That is, when excessive amount of water is supplied to the water bottle 72 and the water overflows from the water bottle 72, the tray 125 may collect the water overflowing from the water bottle 72.

When the water overflows from the water bottle 72, the water overflowing from the water bottle 72 may be guided to the tray 125 through an overflow hole 108a of the main case 101.

The tray 125 may be provided with the overflow sensor 76 configured to detect water collected in the tray 125. When the overflow sensor 76 detects that a predetermined amount of water is collected in the tray 125, the overflow sensor 76 may transmit a signal to a controller 20 to control the control valve 80 to block the water supply to the water bottle 72.

A drain 126 provided to discharge water collected in the tray 125 to the outside may be formed in the tray 125. The drain 126 may be equipped with a stopper 127 configured to open and close the drain 126. The stopper 127 may be provided to close the drain 126 under normal circumstances, and when the stopper 127 is separated from the drain 126, the water collected in the tray 125 may be discharged to the outside.

The water bottle sensor 74 may be provided in the upper portion of the main case 101 to detect whether the water bottle 72 is mounted. The water bottle sensor 74 may be provided as a Hall sensor. The water bottle sensor 74 may detect a magnet 148 (FIG. 24) provided in the water bottle 72. The water bottle sensor 74 may be covered by the case cover 120 and not exposed to the outside.

The water bottle sensor 74 may detect whether the water bottle 72 is mounted on the water bottle mounting space 73 of the water supply case 100. When the water bottle 72 is not mounted, the water bottle sensor 74 may transmit a signal for controlling the control valve 80 to the controller 20 so as to block the water supply to the water bottle 72. Accordingly, it is possible to prevent the water supply to the water bottle 72 when the water bottle 72 is not properly mounted.

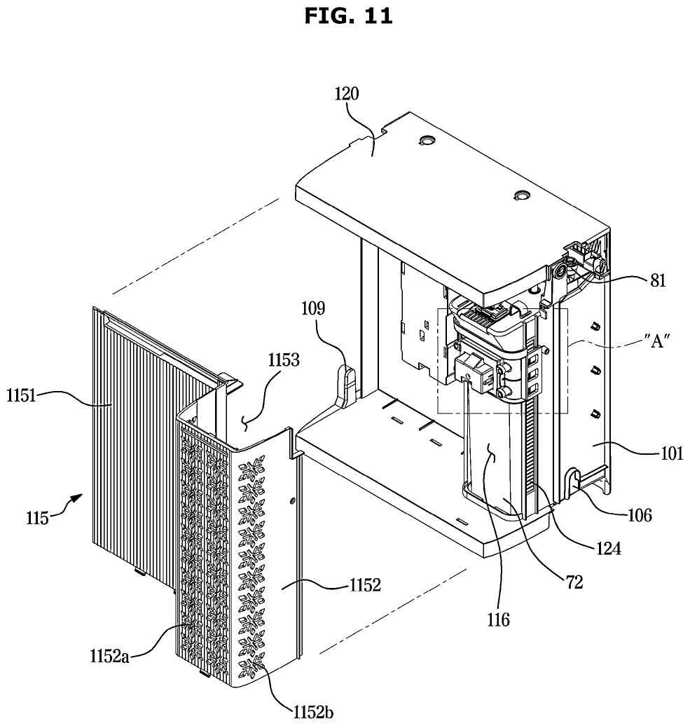

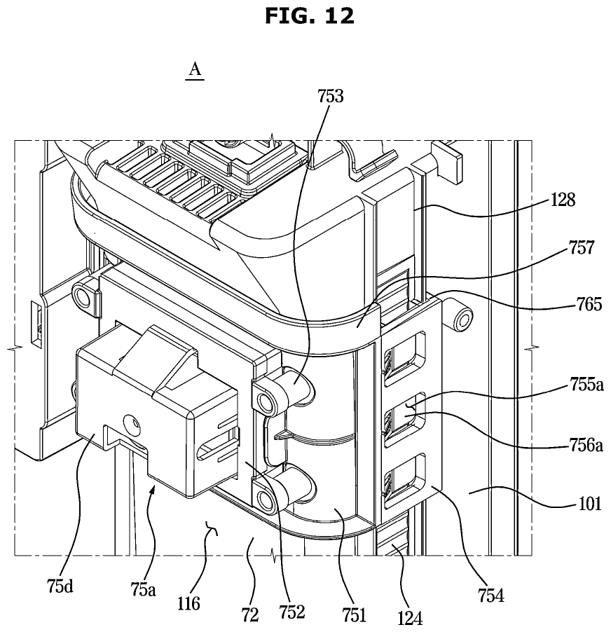

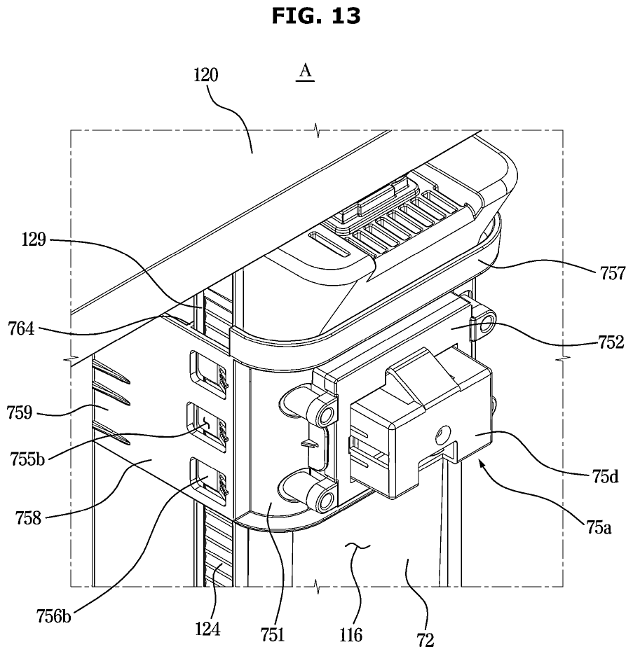

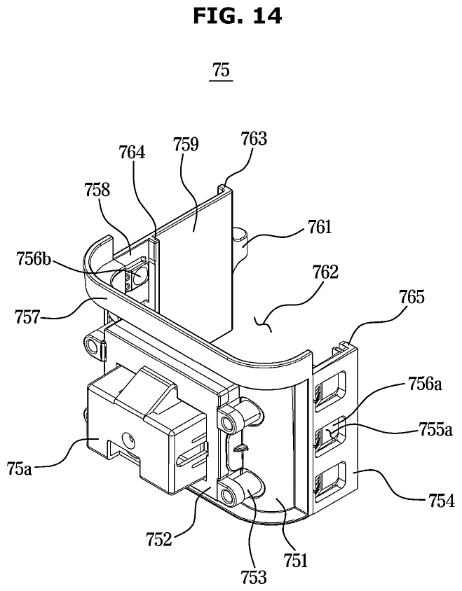

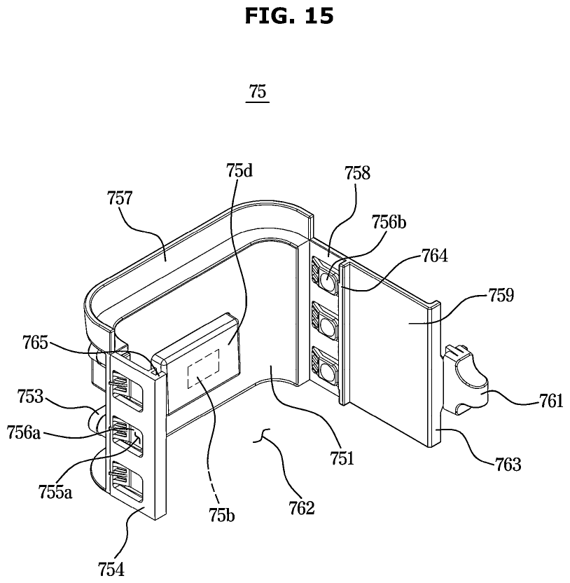

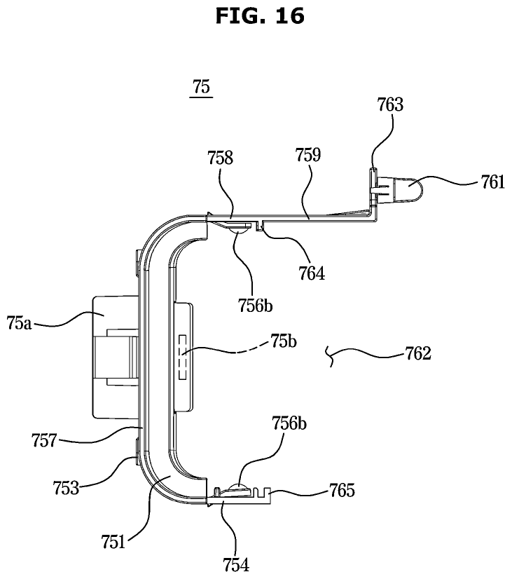

FIG. 11 is a perspective view illustrating a state in which a rear cover is separated from the water supply unit of the refrigerator according to an embodiment of the disclosure. FIG. 12 is an enlarged view of a portion A in FIG. 11. FIG. 13 is a view illustrating FIG. 12 when viewed from another angle. FIG. 14 is a view illustrating a carrier separated from the refrigerator according to an embodiment of the disclosure. FIG. 15 is a view illustrating the carrier separated from the refrigerator according to an embodiment of the disclosure. FIG. 16 is a top view illustrating the carrier separated from the refrigerator according to an embodiment of the disclosure.

Referring to FIGS. 11 to 16, the refrigerator 1 may include the rear cover 115 coupled to the rear side of the main case 101. The rear cover 115 may form the rear exterior of the water supply unit 60.

The main case 101 may include a cutout portion 116 formed by cutting a portion of a rear portion of the water bottle mounting space 73.

The cutout portion 116 may be formed to extend in the vertical direction to allow the water bottle mounting space 73 to communicate with the rear side of the main case 101. When the water bottle 72 is mounted on the water bottle mounting space 73, the cutout portion 116 may be formed to expose one surface of the water bottle 72, which faces the rear side, to the rear side of the main case 101.

The rear cover 115 may include a first rear cover portion 1151 provided to cover a rear side of the dispenser 61. The first rear cover portion 1151 may have an approximate plate shape, but is not limited thereto.

The rear cover 115 may define the storage compartment 21 and the water bottle mounting space 73. Particularly, the rear cover 115 may include a second rear cover portion 1152 extending from the first rear cover portion 1151 and covering the cutout portion 116. The second rear cover portion 1152 may have a shape that protrudes backward.

An inner space that is formed as the second rear cover portion 1152 protrudes may be defined as a carrier receiving groove 1153. A carrier 75, which will be described later, may be accommodated in the carrier receiving groove 1153 and move in the vertical direction. The carrier receiving groove 1153 may communicate with the water bottle mounting space 73.

The second rear cover portion 1152 may include a plurality of holes 1152a and 1152b formed to correspond to a direction in which the cutout portion 116 extends. One surface of the second rear cover portion 1152 facing the rear side may include a plurality of first holes 1152a. The other side of the second rear cover portion 1152 facing the lateral side may include a plurality of second holes 1152a. The plurality of first holes 1152a and the plurality of second holes 1152b may be arranged in a parallel direction.

The carrier receiving groove 1153 may communicate with the storage compartment 21 through the plurality of holes 1152a and 1152b. Accordingly, the water bottle mounting space 73 may communicate with the storage compartment 21 through the cutout portion 116, the carrier receiving groove 1153, and the plurality of holes 1152a and 1152b. Accordingly, cold air of the storage compartment 21 may flow into the water bottle mounting space 73, thereby effectively cooling the water in the water bottle 72.

The carrier 75 may be disposed between the main case 101 and the rear cover 115. The water level sensor 75a may be mounted on the carrier 75.

The carrier 75 and the water level sensor 75a may be coupled to the rear surface of the main case 101. However, the positions of the carrier 75 and the water level sensor 75a are not limited thereto, and may be disposed in any position as long as the carrier 75 and the water level sensor 75a move in the vertical direction and detect the water level of the water bottle 72.

The carrier 75 may be installed in the main case 101 of the water supply case 100 to be movable in the vertical direction.

The carrier 75 may be coupled to the main case 101 of the water supply case 100 to cover a portion of the cutout portion 116 from the rear side.

The water level sensor 75a may be provided as a capacitance sensor capable of detecting the water level inside the water bottle 72 by detecting capacitance that changes depending on the level of the liquid inside the water bottle 72. Because the water level sensor 75a is configured to detect the water level inside the water bottle 72 without directly contacting the liquid inside the water bottle 72, the water level sensor 75a may be provided with a relatively simple configuration and provide relatively accurate detection results.

It is required that the water level sensor 75a be in contact with the water bottle 72 to detect the water level inside the water bottle 72. For this, the water level sensor 75a may include a sensor bracket 75d fixed to the main case 101, a sensor portion 75b configured to detect the water level of the water bottle 72, and an elastic member 75c (FIG. 24) provided to press the sensor portion 75b toward the water bottle 72.

The main case 101 of the water supply case 100 may include a plurality of locking projections 124 arranged in the vertical direction and provided to support the carrier 75 to selectively adjust a height of the carrier 75. The plurality of locking projections 124 may be arranged in the vertical direction on the left and right sides with respect to the cutout portion 116.

Particularly, the carrier 75 may include a body portion 751 provided to cover a portion of the cutout portion 116, and support portions 754 and 758 protruding forward from both sides of the body portion 751, respectively, to allow the body portion 751 to be supported by the main case 101 of the water supply case 100.

The support portions 754 and 758 may be arranged to extend to cover the plurality of locking projections 124 from the outside.

The support portions 754 and 758 each may protrude forward from the both sides of the body portion 751. Accordingly, a space surrounded by the support portions 754 and 758 and the body portion 751 may be formed, and the space may be defined as a receiving groove 762. The receiving groove 762 may be arranged to accommodate a portion of the main case 101 forming the water bottle mounting space 73.

The carrier 75 may include locking protrusions 756a and 756b provided to be locked to or released from the plurality of locking projections 124. The locking protrusions 756a and 756b may be formed on the support portions 754 and 758, respectively.

Protrusion grooves 755a and 755b may be formed in the support portions 754 and 758, respectively. One end of the locking protrusions 756a and 756b may be disposed to be attached to the support portions 754 and 758 and inserted into the protrusion grooves 755a and 755b

The locking protrusions 756a and 756b may be formed to protrude in a direction toward the water bottle mounting space 73.

Because only one end of the locking protrusions 756a and 756b is attached to the support portions 754 and 758, the locking protrusions 756a and 756b may be locked to or released from the plurality of locking projections 124 while elastically moving with respect to the support portions 754 and 758.

The water level sensor 75a may be provided to be coupled to the body portion 751. Particularly, the water level sensor 75a may be coupled to a bracket 752 coupled to the body portion 751.

The bracket 752 may place the water level sensor 75a to the body portion 751 so as to allow the water level sensor 75a to move in the forward and backward directions. The bracket 752 may be coupled to the body portion 751 through a coupling portion 753. For example, the coupling portion 753 may be a screw coupling using a screw or the like.

The main case 101 of the water supply case 100 may include guide rails 128 and 129 extending along a direction, in which the plurality of locking projections 124 extends, to guide the movement of the carrier 75.

The guide rails 128 and 129 may be formed on side surfaces of the plurality of locking projections 124 to protrude in a direction away from the water bottle mounting space 73. The direction in which the plurality of locking projections 124 protrudes may correspond to a direction in which the guide rails 128 and 129 protrude. The guide rails 128 and 129 may serve to support the carrier 75 to the main case 101.

The carrier 75 may include protruding ribs 764 and 765 supported on the guide rails 128 and 129. The protruding ribs 764 and 765 may be formed to protrude from the support portions 754 and 758 toward the water bottle mounting space 73.

The protruding ribs 764 and 765 may be arranged to cover the guide rails 128 and 129 from the front side, respectively. In other words, the protruding ribs 764 and 765 may be supported on front surfaces of the guide rails 128 and 129, respectively.

The carrier 75 may include a handle portion 759 extending forward from one support portion 758 of the support portions 754 and 758. A bent portion 763 may be formed on one protruding end of the handle portion 759. An adjustment button 761 may be attached to one surface formed by the bent portion 763. An operation process of the handle portion 759 and the adjustment button 761 will be described later.

The carrier 75 may include an auxiliary cover 757 provided to protrude upward from the body portion 751. The auxiliary cover 757 may have a bent shape that extends from an upper portion of the body portion 751 toward a rear portion and then extends upward. The auxiliary cover 757 may be formed to extend along an upper edge of the body portion 751.

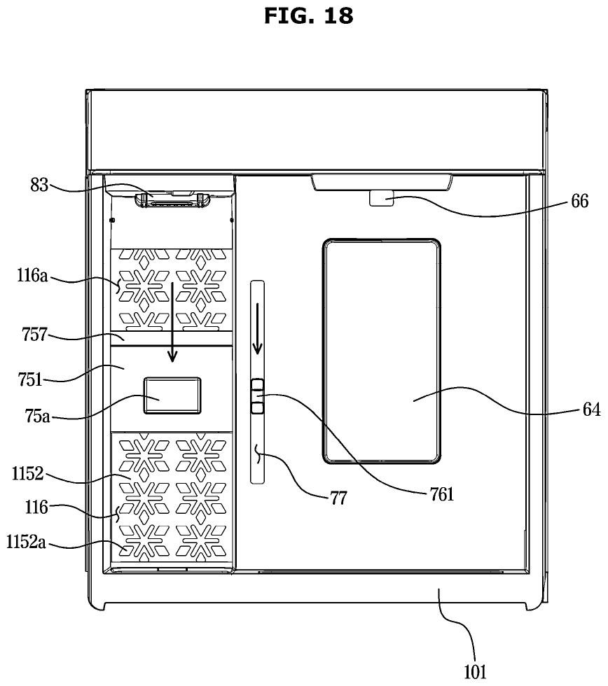

The auxiliary cover 757 may further cover an upper portion 116a (FIG. 18) of the cutout portion 116 that is not covered by the body portion 751 when the body portion 751 covers a portion of the cutout portion 116. A description of the feature in which the auxiliary cover 757 further covers the upper portion 116a of the cutout portion 116 will be described later.

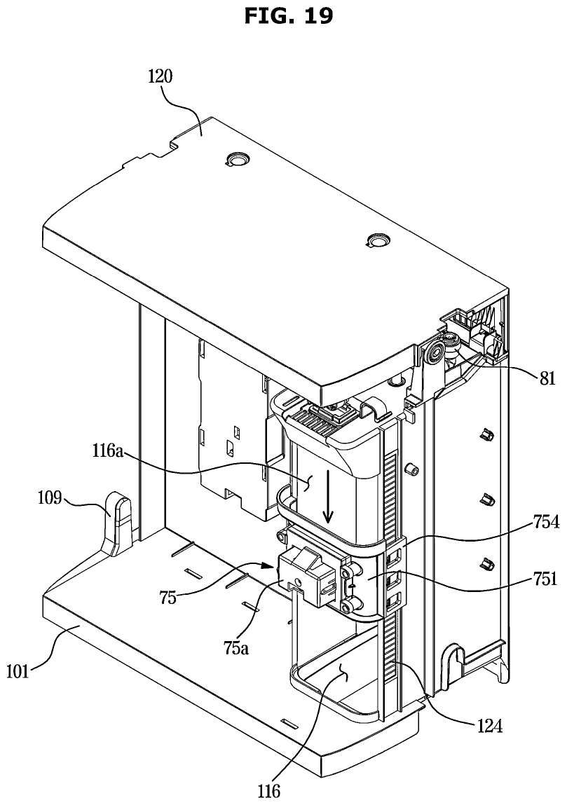

FIG. 17 is a front view of a water supply device of the refrigerator according to an embodiment of the disclosure. FIG. 18 is a view illustrating a state in which the carrier is lowered in the water supply device of the refrigerator according to an embodiment of the disclosure. FIG. 19 is a rear perspective view illustrating a state in which the carrier is lowered in FIG. 16 with the rear cover removed.

Referring to FIGS. 17 to 19, the main case 101 of the water supply case 100 may include a guide hole 77 (refer to FIG. 17) formed to extend along the vertical direction on a lateral portion of the water bottle mounting space 73 and the front surface of the main case 101.

The handle portion 759 may be disposed to protrude toward the front side of the main case 101 by passing through the guide hole 77 formed on the front surface of the main case 101 of the water supply case 100. Accordingly, the adjustment button 761 mounted on the end of the handle portion 759 may protrude toward the front side of the main case 101.

A user can access the adjustment button 761 by opening only the outer door 36. A user can press the adjustment button 761 in the up and down direction along the guide hole 77.

For example, when a user presses the adjustment button 761, which is placed at a full water level position, downward, the handle portion 759, to which the adjustment button 761 is connected, may press the support portions 754 and 758 and the body portion 751 downward. At this time, the locking protrusions 756a and 756b, which are maintained in a locked state on the plurality of locking projections 124, may be pressed to a direction away from the water bottle mounting space 73 by a protruding portion of the plurality of locking projections 124 and then the locking protrusions 756a and 756b may move.

When the locking protrusions 756a and 756b move in a direction away from the water bottle mounting space 73, the locking protrusions 756a and 756b may be released from the plurality of locking projections 124.

When the locking protrusions 756a and 756b are released from the plurality of locking projections 124, the protruding ribs 764 and 765 may be guided downward through the guide rails 128 and 129. Accordingly, the carrier 75 may move downward.

When the carrier 75 is moved downward, the water level sensor 75a mounted on the body portion 751 may also be moved downward. As the water level sensor 75a is moved downward, a sensing height for detecting the water level in the water bottle 72 may also be adjusted downward. Accordingly, it is possible to adjust the water level of the water bottle 72 placed in the water bottle mounting space 73.

On the other hand, even when the water level sensor 75a is at the full water level position, a gap C may occur on the side of the upper cutout portion 116a between the body portion 751 and the main case 101 in contact with the body portion 751.

A light source (not shown) may be disposed in the storage compartment 21 to illuminate the storage compartment 21, but when light shines to the outside through the gap C, aesthetics may be reduced.

When the water level sensor 75a is at the full water level position, the auxiliary cover 757 may cover the gap C, which is between the body portion 751 and the main case 101 in contact with the body portion 751, from the rear side of the upper cutout portion 116a. Therefore, it is possible to maintain the aesthetics by preventing light of the storage compartment 21 from shining to the outside.

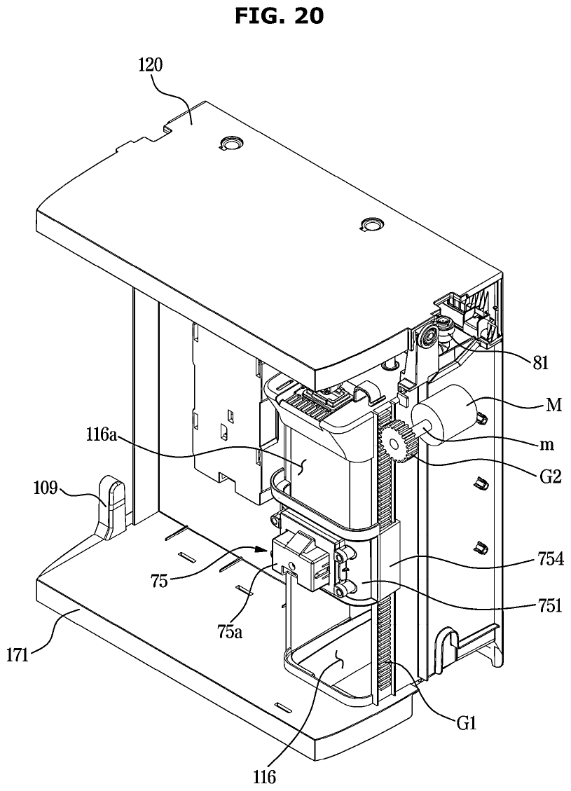

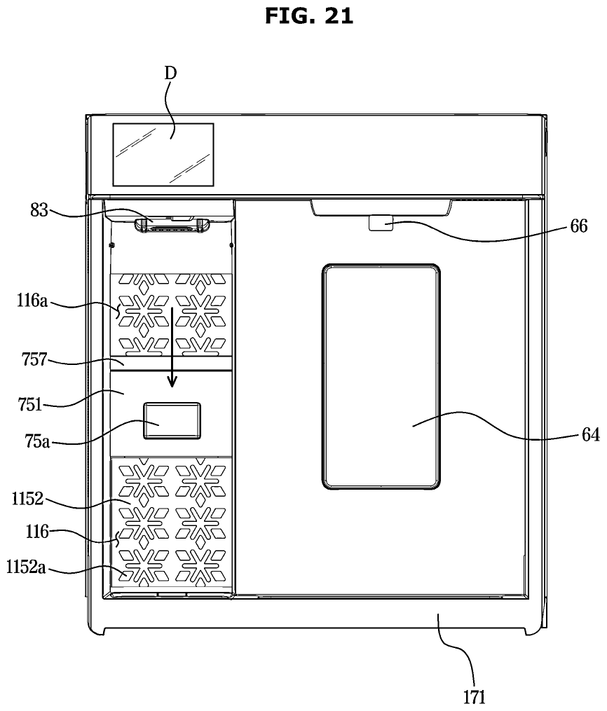

FIG. 20 is a rear perspective view illustrating a state in which a carrier is lowered in a water supply device of a refrigerator according to an embodiment of the disclosure, with a rear cover removed. FIG. 21 is a front view illustrating a state in which the carrier of FIG. 20 is lowered. Hereinafter a description of content that is the same as the above will be omitted.

Referring to FIGS. 20 and 21, a refrigerator 2 may include a motor M, a first gear G1 disposed on the left and right sides of a cutout portion 116 formed in a main case 171 and coupled to a carrier 45, and a second gear G2 connecting the motor M and the first gear G1 to transmit power of the motor M to the first gear G1.

The motor M may be attached to the main case 171. When the motor M is driven, the power of the motor M may rotate the second gear G2 through a motor shaft m. The second gear G2 may be connected to the first gear G1 so as to transmit the power of the motor M to the first gear G1.

The first gear G1 may be moved by the rotation of the second gear G2, and the carrier 45 coupled to the first gear G1 may be also moved together with the first gear G1. Accordingly, the carrier 45 may move in the vertical direction, and a full water level of a water bottle may be adjusted by adjusting a sensing height that is a height at which a water level sensor 45a attached to the carrier 45 senses a water level of the water bottle 72.

For example, the first gear G1 may be a rack gear having a linear shape. For example, the second gear G2 may be a pinion gear configured to transmit power to the rack gear.

The arrangement and power transmission process of the motor M, the first gear G1, and the second gear G2 are merely examples, and it is possible to include various cases in which the carrier 45 is configured to move in the vertical direction.

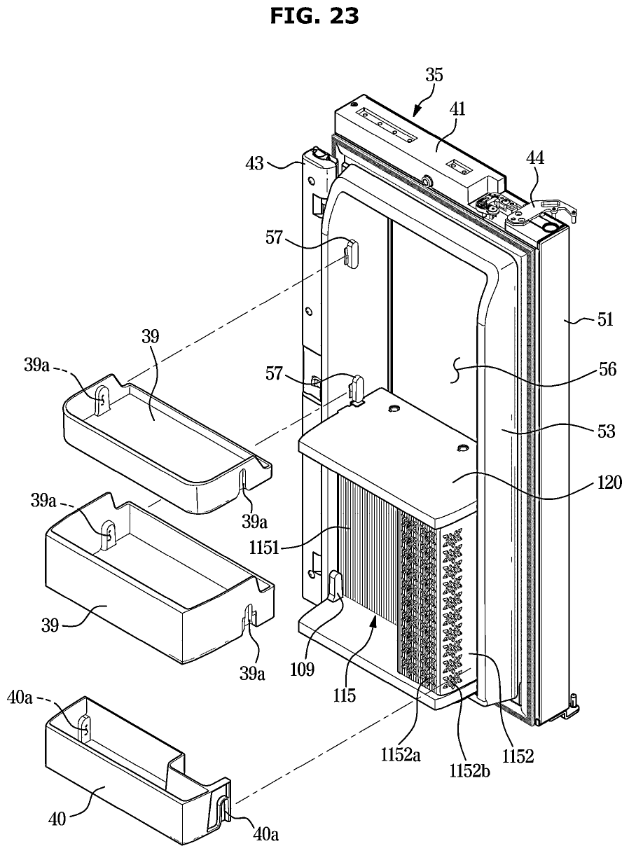

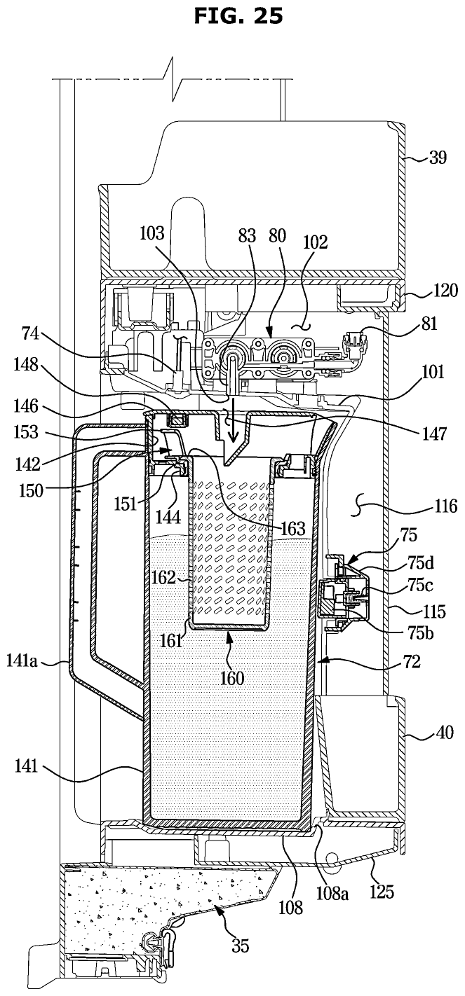

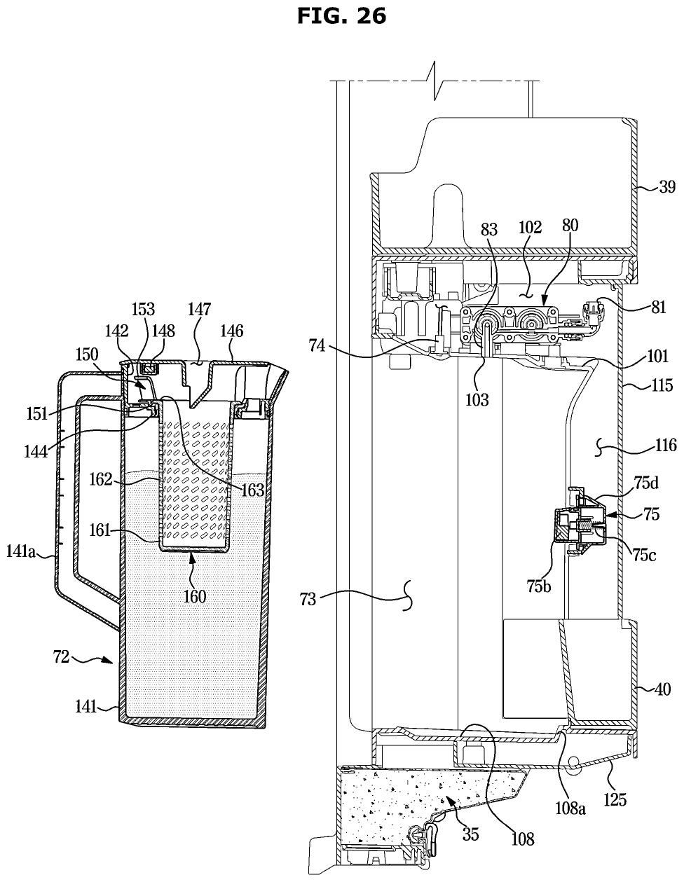

FIG. 22 is a view illustrating a coupling structure between the water supply unit and the inner door of the refrigerator according to an embodiment of the disclosure. FIG. 23 is a view illustrating a coupling structure of a door basket of the refrigerator according to an embodiment of the disclosure. FIG. 24 is a side cross-sectional view illustrating the water supply device equipped with a water bottle of the refrigerator according to an embodiment of the disclosure. FIG. 25 is a side cross-sectional view illustrating the water supply device equipped with the water bottle of the refrigerator according to an embodiment of the disclosure. FIG. 26 is a view illustrating a state in which the water bottle is separated from the water supply device of the refrigerator according to an embodiment of the disclosure.

Referring to FIGS. 22 to 26, as described above, the main case 101 may be disposed in the door inner space 56 of the inner door 35. Particularly, the main case 101 may be coupled to the door inner surface 55 forming the door inner space 56.

For this, a bead groove 106 may be formed on the both side surfaces of the main case 101, respectively. The main case 101 may be disposed in the door inner space 56 of the inner door 35 by inserting the second door bead 58 of the inner door 35 into the bead groove 106.

The main case 101 may be coupled to the inner door 35 through a fastening member S1 such as a screw to allow the main case 101 to be firmly coupled to the door inner space 56 of the inner door 35. For this, the main case 101 may be provided with a coupling hole 105 into which the fastening member S1 is coupled, and the fastening hole 55b into which the fastening member S1 is fastened may be provided on the inner surface 55 of the inner door 35. The main case 101 may include a coupling bracket 104 provided to protrude upward, and the coupling hole 105 may be formed in the coupling bracket 104.

With this configuration, after inserting the second door bead 58 of the inner door 35 into the bead groove 106 of the main case 101, the fastening member S1 may be fastened to the coupling hole 105 of the main case 101 and the fastening hole 55b of the inner door 35. Accordingly, the main case 101 may be coupled to the inner door 35. Conversely, the main case 101 may be separated from the inner door 35 by separating the fastening member S1 and by separating the second door bead 58 from the bead groove 106.

The door baskets 39 and 40 may include a door basket 39 mounted on the first door bead 57 of the inner door 35, and a door basket 40 mounted on a case bead 109 of the water supply case 100.

As a bead groove 39a is formed on both sides of the door basket 39, respectively and the first door bead 57 is inserted into the bead groove 39a, the door basket 39 may be mounted on the inner door 35.

As a bead groove 40a is formed on both sides of the door basket 40, respectively and the case bead 109 of the water supply case 100 is inserted into the bead groove 40a, the door basket 40 may be mounted on the water supply case 100.

Referring to FIG. 24, the water bottle 72 may include a water bottle body 141 provided to store water, a water bottle middle cover 142 coupled to an upper portion of the water bottle body 141, an infuser 160 provided to receive a tea bag, and an infuser ring 150 provided to allow the infuser 160 to be easily attached to or detached from the water bottle middle cover 142.

The water bottle body 141 may store a predetermined amount of water. The water bottle body 141 may be formed of a transparent material to allow the water stored therein to be confirmed. The water bottle body 141 may include a water bottle handle 141a provided to be easily held by a user and provided to allow the user to mount the water bottle body 141 to the water bottle mounting space 73 or to separate the water bottle body 141 from the water bottle mounting space 73.

The water bottle middle cover 142 may be coupled to the water bottle body 141 by a tight-fitting method. The water bottle middle cover 142 may include a cover opening 143 into which the infuser 160 is inserted. A ring support portion 144 on which a ring portion 151 of the infuser ring 150 is seated may be formed around the cover opening 143. The water bottle middle cover 142 may include an open upper surface to facilitate installation of the infuser 160.

A water bottle upper cover 146 may be formed to cover the open upper surface of the water bottle middle cover 142. The water bottle upper cover 146 may include the inlet 147 to allow water to flow into the water bottle body 141. When the water bottle 72 is mounted on the water bottle mounting space 73, the inlet 147 may be disposed to correspond to the valve through-hole 103 formed on the upper surface of the main case 101 and the second outlet port 83 of the control valve 80.

The magnet 148 may be disposed on the water bottle upper cover 146. The magnet 148 may be disposed at a position corresponding to the water bottle sensor 74 when the water bottle 72 is mounted on the water bottle mounting space 73.

The infuser 160 may include a strainer 161 formed to hold tea bags, etc. The strainer 161 may be formed in a cylindrical shape. A through hole 162 may be formed in the strainer 161 to allow water to pass through the strainer 161. A rim 163 may be formed at an upper end of the strainer 161 to protrude radially outward.

The infuser ring 150 may include the ring portion 151 including a ring opening 152 into which the infuser 160 is inserted, and a ring handle 153 protruding from the ring portion 151. When the infuser 160 is inserted into the ring opening 152 of the infuser ring 150 from top to bottom, a lower surface of the rim 163 of the infuser 160 may be seated on an upper surface of the ring portion 151.

A user can mount the infuser 160 to the water bottle 72 by holding the ring handle 153 in a state in which the infuser 160 is seated on the infuser ring 150 and placing the lower surface of the ring portion 151 of the infuser ring 150 to the ring support portion 144 of the water bottle middle cover 142. When separating the infuser 160 from the water bottle 72, a user can easily separate the infuser 160 from the water bottle 72 by holding the ring handle 153 of the infuser ring 150.

The sensor portion 75b may be arranged to be in contact with the water bottle 72 when the water bottle 72 is mounted on the water bottle mounting space 73. The sensor portion 75b may be provided to be movable in the forward and backward directions with respect to the sensor bracket 75d.

When a predetermined amount of water is stored in the water bottle 72, the water level sensor 75a may transmit a signal to the controller 20 to control the control valve 80 to block water supply to the water bottle 72. On the other hand, the water level sensor 75a may transmit a signal to the controller 20 to control the control valve 80 to supply water to the water bottle 72 when water that is less than the predetermined amount of water is stored in the water bottle 72.

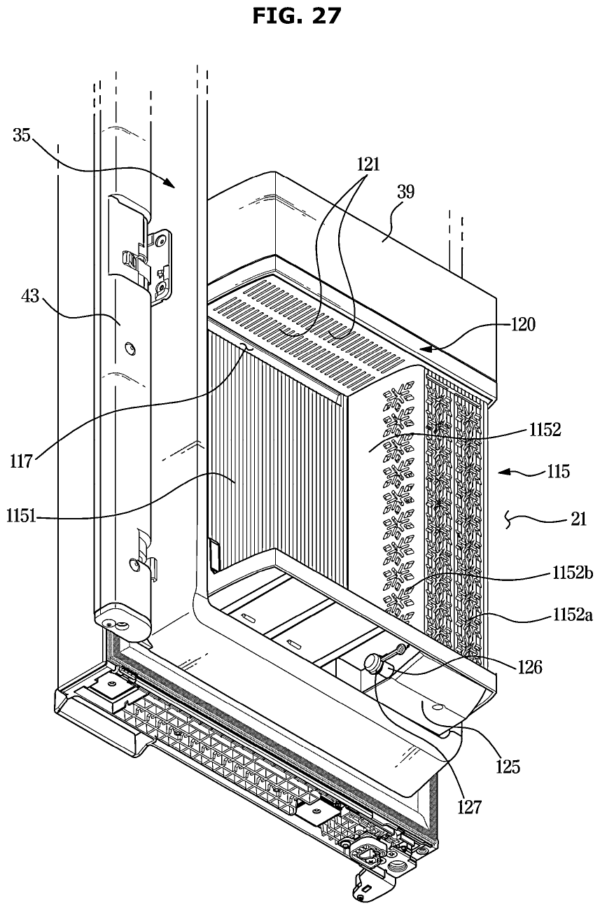

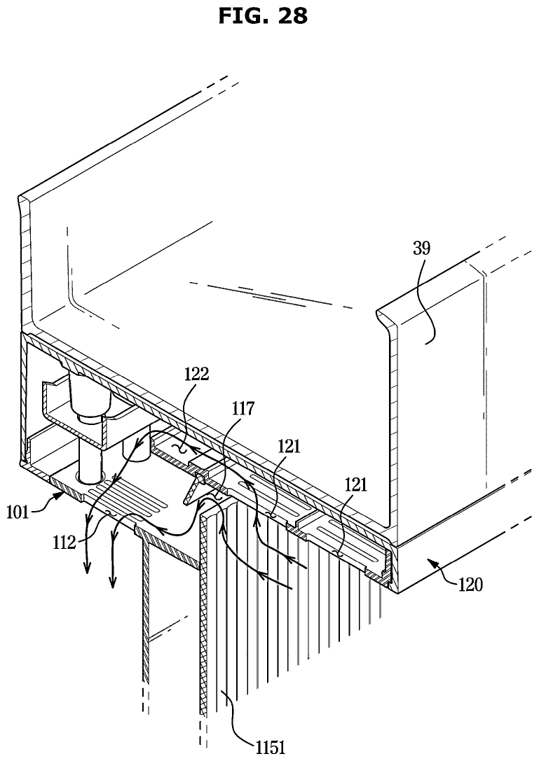

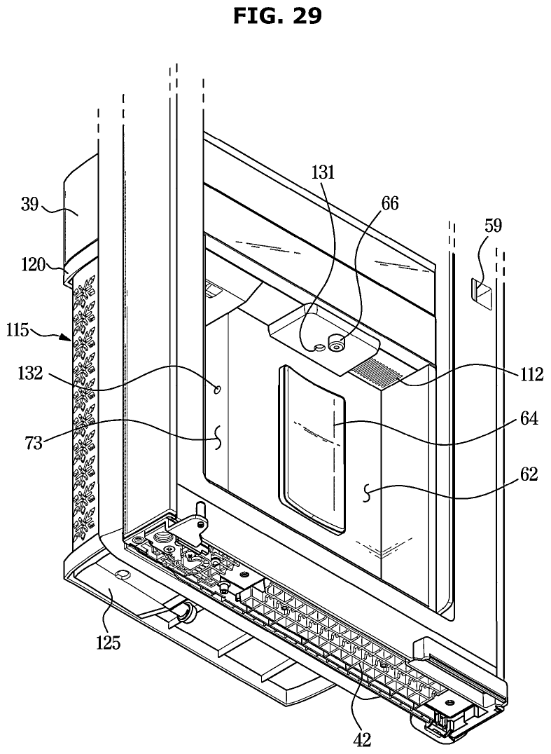

FIG. 27 is a view illustrating a rear surface of the inner door of the refrigerator according to an embodiment of the disclosure. FIG. 28 is a cross-sectional view of the water supply case illustrating a flow of cold air in the refrigerator according to an embodiment of the disclosure. FIG. 29 is a view illustrating a front surface of the inner door of the refrigerator according to an embodiment of the disclosure.

Referring to FIGS. 27 to 29, the water supply case 100 may include a cold air hole formed in the water supply case 100 to allow the cold air of the storage compartment 21 to be smoothly supplied to the water intake space 62 and the water bottle mounting space 73 formed on the front surface of the water supply case 100.

The cold air hole may include a first cold air hole 121 formed in the case cover 120 and a second cold air hole 112 formed in the main case 101.

The cold air that flows into an inner space 122 between the case cover 120 and the main case 101 through the first cold air hole 121 may be guided to the water intake space 62 and the water bottle mounting space 73 through the second cold air hole 112.

The cold air hole may include a third cold air hole 117 formed between the case cover 120 and the rear case 115. The cold that flows into the inner space 122 between the case cover 120 and the main case 101 through the third cold air hole 117 may be guided to the water intake space 62 and the water bottle mounting space 73 through the second cold air hole 112.

Because the cold air of the storage compartment 21 is smoothly supplied to the water intake space 62 and the water bottle mounting space 73 through the cold air hole, it is possible to efficiently cool the water bottle 72 mounted on the water bottle mounting space 73.

The water supply case 100 may be provided with lamps 131 and 132. A first lamp 131 may be provided on the upper side of the water intake space 62 to illuminate the operating lever 64. A second lamp 132 may be provided on the lateral side of the water bottle mounting space 73 to illuminate the water bottle 72. The first lamp 131 and the second lamp 132 may be configured to be turned on and off in conjunction with the opening and closing of the outer door 36.

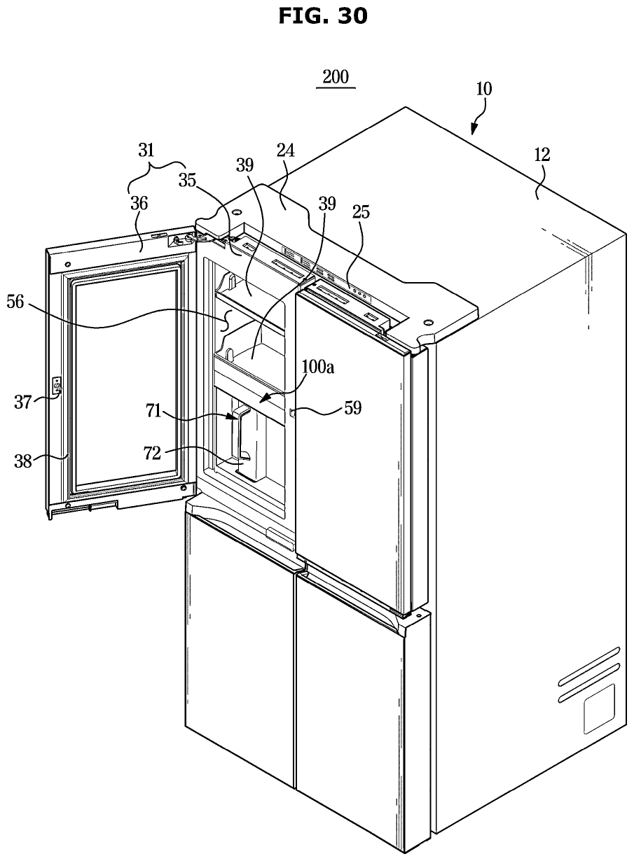

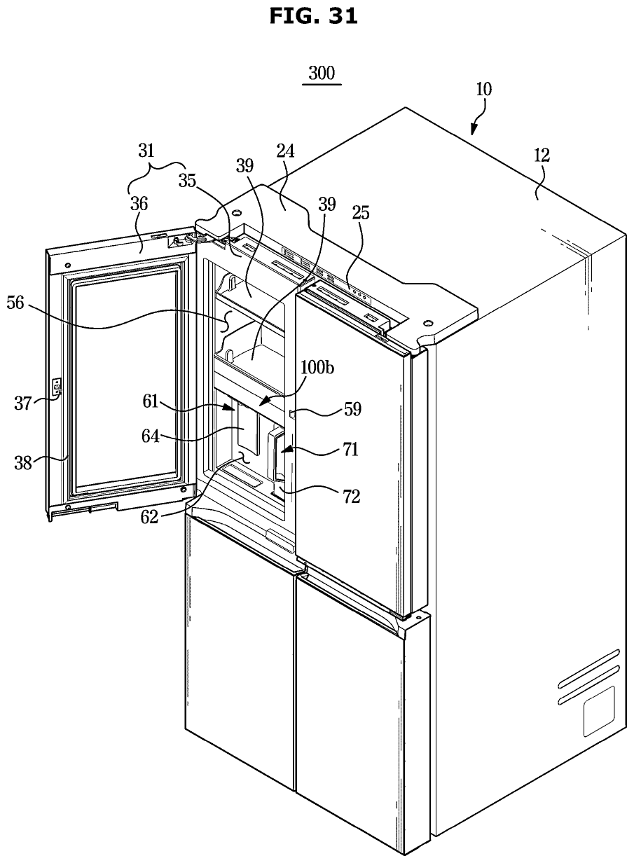

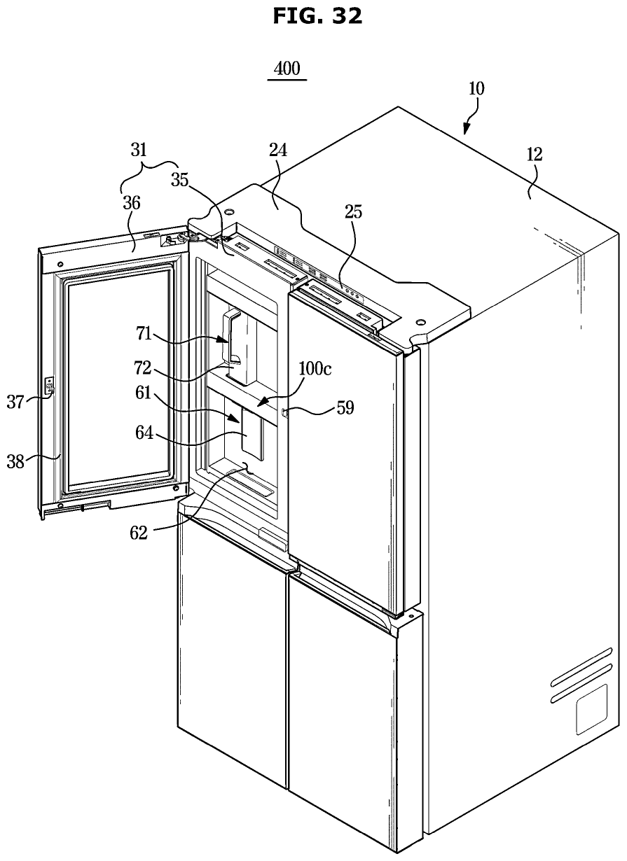

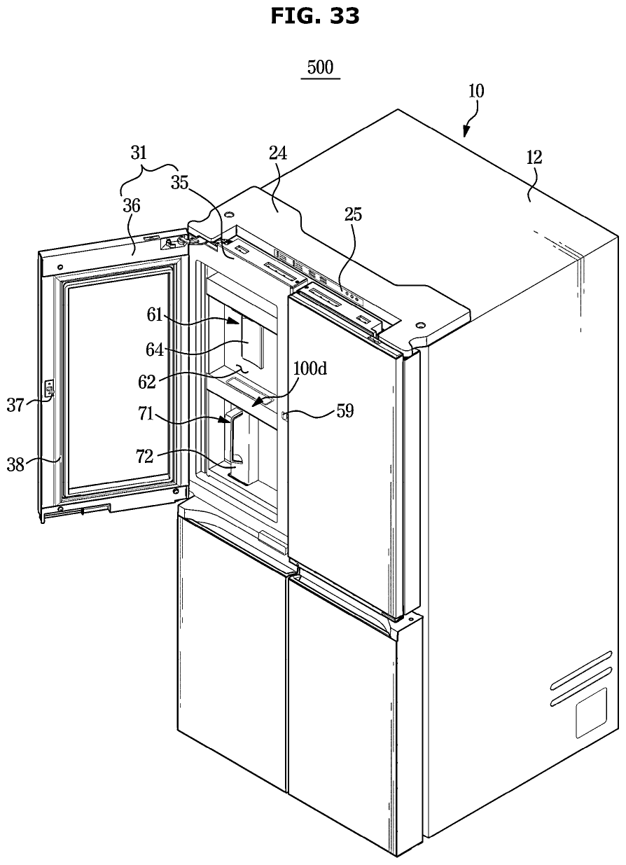

FIG. 30 is a view illustrating a state in which an outer door of a refrigerator 200 according to an embodiment of the disclosure is open. FIG. 31 is a view illustrating a state in which an outer door of a refrigerator 300 according to an embodiment of the disclosure is open. FIG. 32 is a view illustrating a state in which an outer door of a refrigerator 400 according to an embodiment of the disclosure is open. FIG. 33 is a view illustrating a state in which an outer door of a refrigerator 500 according to an embodiment of the disclosure is open.

Hereinafter the same reference numerals may be assigned to the same components as the above-described embodiments, and a description thereof may be omitted.

As illustrated in FIG. 30, the dispenser may be omitted in the refrigerator of the above-described embodiment. In this case, the control valve may be configured as a two-way valve rather than a three-way valve, and the flow path provided to guide water from the water supply flow path to the dispenser may be omitted.

As illustrated in FIG. 31, the positions of the dispenser and the automatic water supply device of the refrigerator according to the above-described embodiment may be switched to each other.

As illustrated in FIGS. 32 and 33, the dispenser and the automatic water supply device of the refrigerator of the above-described embodiment may be arranged in the vertical direction rather than the left and right directions. The automatic water supply device may be disposed above the dispenser or, conversely, the dispenser may be disposed above the automatic water supply device. In this case, the door guard disposed above the automatic water supply device and the dispenser of the refrigerator in the above-described embodiment may be omitted.

In the embodiments of FIGS. 30 to 33, internal structures of water supply cases 100a, 100b, 100c, and 100d may be appropriately omitted or changed depending on whether the dispenser is omitted and according to the positions of the dispenser and the automatic water supply device.

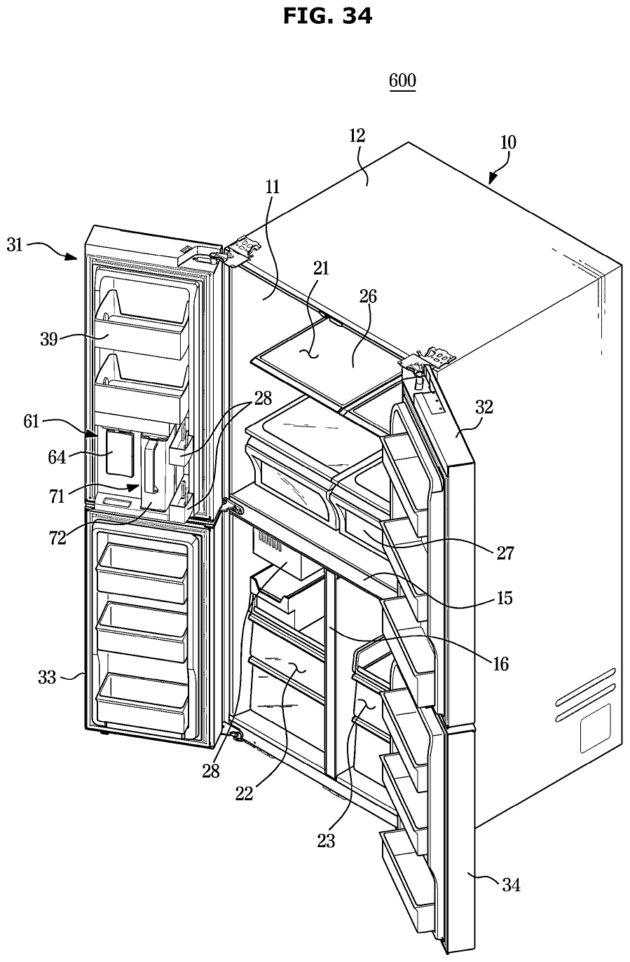

FIG. 34 is a view illustrating a state in which a single door of a refrigerator 600 according to an embodiment of the disclosure is open.

Hereinafter the same reference numerals may be assigned to the same components as the above-described embodiments, and a description thereof may be omitted. Further, as the water supply device is disposed in a single door, an internal structure may be appropriately omitted or changed.

Referring to FIG. 34, a door of a refrigerator 600 may also be applied to a single door 31. In this case, a water supply device 71 may be disposed behind the single door 31 facing a storage compartment 21. A user can access the water supply device 71 by opening the single door 31.

In the drawings, a dispenser 61 may be provided, but the dispenser 61 may be omitted according to various examples.

The refrigerator 1 according to an embodiment of the disclosure may include the main body 10 including the storage compartment 21, the doors 31 and 32 rotatably coupled to the main body 10 so as to open and close the storage compartment 21, and the water supply device 71 disposed at the door 31. The water supply device 71 may include the water supply case 100 including the water bottle mounting space 73 provided to allow the water bottle 72 to be mounted thereto. The water supply device 71 may include the water level sensor 75a configured to detect a water level of the water bottle 72 mounted to the water bottle mounting space 73. The water supply device 71 may include the carrier 75 to which the water level sensor 75a is coupled. The carrier 75 may be mounted on the water supply case 100 to be movable in the vertical direction so as to adjust the sensing height at which the water level sensor 75a senses the water level of the water bottle 72.

The water supply case 100 may include the plurality of locking projections 124 arranged in the vertical direction to support the carrier 75 so as to selectively adjust the height of the carrier 75. The carrier 75 may include the locking protrusions 756a and 756b provided to be locked to or released from the plurality of locking projections 124.

The water supply case 100 may include the guide rails 128 and 129 extending along the direction, in which the plurality of locking projections 124 extends, to guide the movement of the carrier 75. The carrier 75 may include the protruding rib supported on the guide rail 128.

The door 31 may include the inner door 35 including the door inner space 56 provided to communicate with the storage compartment 21, and the outer door 36 configured to be rotatable in front of the inner door 35. The water supply device 71 may be arranged to be accommodated in the door inner space 56.

The water supply case 100 may include the cutout portion 116 formed to extend in the vertical direction at the rear side of the water bottle mounting space 73 to allow at least one surface of the water bottle 72 to communicate with the storage compartment 21. The carrier 75 may be coupled to the water supply case 100 so as to cover a portion of the cutout portion 116 from the rear side.

The carrier 75 may include the body portion 751 provided to cover a portion of the cutout portion 116. The carrier 75 may include the support portions 754 and 758 provided to protrude from both sides of the body portion 751 to support the body portion 751 to the water supply case 100. The water level sensor 75a may be provided to be coupled to the body portion 751.

The water supply case 100 may further include the guide hole 77 extending in the vertical direction on the lateral portion of the water bottle mounting space 73. The carrier 75 may further include the handle portion 759 extending forward from one support portion 758 of the support portions 754 and 758. The handle portion 759 may be disposed to pass through the guide hole 77 and to protrude toward the front side of the water supply case 100.

The refrigerator 1 may further include the rear cover 115 mounted on the water supply case 100 to cover the rear side of the cutout portion 116 so as to allow the water bottle mounting space 73 and the storage compartment 21 to be partitioned from each other.

The rear cover 115 may be provided to allow the water bottle mounting space 73 to communicate with the storage compartment 51 as a portion of the rear cover 115 provided to cover the cutout portion 116 includes the plurality of holes 1152a and 1152b arranged in the direction in which the cutout portion 116 extends.

The carrier 75 may further include the auxiliary cover 757 provided to protrude upward from the body portion 751 to cover a portion of an upper side 116a of the cut portion 116 that is not covered by the body portion 751 in response to the body portion 751 covering a portion of the cutout portion 116.

The refrigerator may further include the motor M, the first gear G1 extending vertically and coupled to the carrier 45, and the second gear G2 provided to connect the motor M to the first gear G1 so as to transmit power of the motor M to the first gear G1.

The first gear G1 may include a rack gear. The second gear G2 may include a pinion gear.

The refrigerator 1 may further include the dispenser 61 including the operating lever 64 and configured to supply water by operating the operating lever 64.

The door 31 may include the single door 31, and the water supply device 71 may be disposed at the rear side of the single door 31 facing the storage compartment 21.

The refrigerator 1 according to an embodiment of the disclosure may include the main body 10 including the storage compartment, the inner door 35 rotatably coupled to the main body 10, the outer door 36 configured to be rotatable in front of the inner door, the dispenser 61 including the operating lever 64 and configured to supply water by operating the operating lever 64, and the water supply device 71 disposed at the inner door 35. The water supply device 71 may include the water supply case 100 including the water bottle mounting space 73 provided to allow the water bottle 72 to be mounted thereto and provided to communicate with the storage compartment 21. The water supply device 71 may include the water level sensor 45a configured to detect a water level of the water bottle 72 mounted to the water bottle mounting space 73. The water supply device 71 may include the carrier 75 to which the water level sensor 75a is coupled. The carrier 75 may be mounted on the water supply case 100 to be movable in the vertical direction so as to adjust the sensing height at which the water level sensor 75a senses the water level of the water bottle 72. The water supply case 100 may include the plurality of locking projections 124 arranged in the vertical direction to support the carrier 75 so as to selectively adjust the height of the carrier 75. The carrier 75 may include the locking protrusions 756a and 756b provided to be locked to or released from the plurality of locking projections 124.

The water supply case 100 may include the cutout portion 116 formed to extend in the vertical direction at the rear side of the water bottle mounting space 73 to allow at least one surface of the water bottle 72 to communicate with the storage compartment 21. The water supply case 100 may include the guide hole 77 extending in the vertical direction on the lateral portion of the water bottle mounting space 73. The carrier 75 may include the body portion 751 provided to cover a portion of the cutout portion 116 and provided to allow the water level sensor 75a to be coupled thereto. The carrier 75 may include the support portions 754 and 758 provided to protrude from both sides of the body portion 751 to support the body portion 751 to the water supply case 100. The carrier 75 may include the handle portion 759 provided to extend forward from one support portion 758 of the support portions 754 and 758 and disposed to pass through the guide hole 77 and to protrude toward the front side of the water supply case 100.

The refrigerator 1 may further include the rear cover 115 mounted on the water supply case 100 to cover the rear side of the cutout portion 116 so as to allow the water bottle mounting space 73 and the storage compartment 21 to be partitioned from each other. The rear cover 115 may be provided to allow the water bottle mounting space 73 to communicate with the storage compartment 51 as a portion of the rear cover 115 provided to cover the cutout portion 116 includes the plurality of holes 1152a and 1152b arranged in the direction in which the cutout portion 116 extends.

The carrier 75 may further include the auxiliary cover 757 provided to protrude upward from the body portion 751 to cover a portion of an upper side of the cut portion 116 that is not covered by the body portion 751 in response to the body portion 751 covering a portion of the cutout portion 116.

The refrigerator 1 according to an embodiment of the disclosure may include the main body 10 including the storage compartment 21, the door 31 rotatably coupled to the main body 10 so as to open and close the storage compartment 21, the dispenser 61 including the operating lever 64 and configured to supply water by operating the operating lever 64, and the water supply device 71 disposed at the rear side of the door 31 facing the storage compartment 21. The water supply device 71 may include the water supply case 100 including the water bottle mounting space 73 provided to allow the water bottle 72 to be mounted thereto, and the plurality of locking projections 124 arranged in the vertical direction. The water supply device 71 may include the water level sensor 75a configured to detect a water level of the water bottle mounted to the water bottle mounting space 73. The water supply device 71 may include the carrier 75 to which the water level sensor 75a is coupled, the carrier mounted on the water supply case 100 to be movable in the vertical direction so as to adjust the sensing height at which the water level sensor 75a senses the water level of the water bottle 72. The carrier 75 may include the locking protrusions 756a and 756b provided to be locked to or released from the plurality of locking projections 124.

Energy loss may be reduced by providing a refrigerator including a structure that allows access to a water supply device without opening an inner door.

Further, usability may be improved by adjusting a full water level of a water bottle by including a structure in which a water level sensor is movable in a vertical direction.

Further, a water supply device applied to a double door may include an auxiliary cover provided to prevent a light from shining onto an upper side of a cutout portion of a storage compartment, and thus aesthetics of a refrigerator may be further improved.

Further, a portion of a rear cover covering a cutout portion may include a plurality of holes, and thus cold air of a storage compartment may effectively flow into a water bottle, thereby cooling water.

Additional aspects of the disclosure will be set forth in part in the description which follows and, in part, will be obvious from the description, or may be learned by practice of the disclosure.

While the present disclosure has been particularly described with reference to exemplary embodiments, it should be understood by those of skilled in the art that various changes in form and details may be made without departing from the spirit and scope of the present disclosure.

1. A refrigerator comprising:
a main body including a storage compartment;
a door coupled to the main body so as to be rotatable to open and close the storage compartment; and
a water supply device at the door, the water supply device including:
a water supply case including a water bottle mounting space to which a water bottle is mountable,
a water level sensor configured to detect, when a water bottle is mounted to the water bottle mounting space, a water level of the water bottle, and
a carrier mounted on the water supply case, and to which the water level sensor is coupled,
wherein the carrier is mounted on the water supply case to be movable in a vertical direction so that a sensing height at which the water level sensor senses the water level of the water bottle is adjustable.

2. The refrigerator of claim 1, wherein
the water supply case includes a plurality of locking projections arranged in the vertical direction to support the carrier at a selected sensing height, and
the carrier includes a locking protrusion to be lockable to, and releasable from, the plurality of locking projections.

3. The refrigerator of claim 2, wherein
the water supply case includes a guide rail to guide a movement of the carrier, the guide rail extending along a direction in which the plurality of locking projections extends, and
the carrier includes a protruding rib arranged to be supported on the guide rail.

4. The refrigerator of claim 1, wherein
the door includes:
an inner door including a door inner space to communicate with the storage compartment, and
an outer door configured to be rotatable in front of the inner door, and
the water supply device is arranged to be accommodated in the door inner space.

5. The refrigerator of claim 4, wherein
the water supply case includes a cutout portion formed to extend in the vertical direction at a rear side of the water bottle mounting space so that, when the water bottle is mounted to the water bottle mounting space, at least one surface of the water bottle communicates with the storage compartment, and
the carrier is coupled to the water supply case so as to cover a portion of the cutout portion from the rear side.

6. The refrigerator of claim 5, wherein
the carrier includes:
a body portion to cover a portion of the cutout portion, and
a plurality of support portions provided to protrude from both sides of the body portion to support the body portion to the water supply case, and
the water level sensor is couplable to the body portion.

7. The refrigerator of claim 6, wherein
the water supply case includes a guide hole extending in the vertical direction on a lateral portion of the water bottle mounting space,
the carrier includes a handle portion extending forward from one support portion of the plurality of support portions, and
the handle portion is disposed to pass through the guide hole and to protrude toward a front side of the water supply case.

8. The refrigerator of claim 5, further comprising:
a rear cover mounted on the water supply case to cover a rear side of the cutout portion so as to partition the water bottle mounting space from the storage compartment.

9. The refrigerator of claim 8, wherein
a portion of the rear cover covering the rear side of the cutout portion includes a plurality of holes arranged in a direction in which the cutout portion extends so that the water bottle mounting space communicates with the storage compartment.

10. The refrigerator of claim 6, wherein
the carrier includes an auxiliary cover protruding upward from the body portion to cover a portion of an upper side of the cutout portion that is not covered by the body portion.

11. The refrigerator of claim 1, further comprising:
a motor;
a first gear coupled to the carrier; and
a second gear connecting the motor to the first gear so as to transmit power of the motor to the first gear.

12. The refrigerator of claim 11, wherein
the first gear includes a rack gear, and
the second gear includes a pinion gear.

13. The refrigerator of claim 1, further comprising:
a dispenser including an operating lever and configured to supply water when the operating lever is operated.

14. The refrigerator of claim 1, wherein
the door includes a single door, and
the water supply device is disposed at a rear side of the single door facing the storage compartment.
